(19) United States
(12) Patent Application Publication
(10) Pub. No.: US 2026/0057039 A1
(43) Pub. Date: Feb. 26, 2026

(54) APPARATUS AND METHOD FOR GENERATING AN OPTIMAL OUTPUT

(71) Applicant: AI Leadership Labs, LLC, Austin, TX (US)

(72) Inventor: Geoff Woods, Austin, TX (US)

(73) Assignee: AI Leadership Labs, LLC, Austin, TX (US)

(21) Appl. No.: 19/308,791

(22) Filed: Aug. 25, 2025

Related U.S. Application Data
(60) Provisional application No. 63/686,237, filed on Aug. 23, 2024.

(51) Int. Cl. G06F 18/21; G06F 18/15; G06F 18/214; G06F 18/23

(52) U.S. Cl. CPC G06F 18/2178; G06F 18/15; G06F 18/214; G06F 18/23

(57) ABSTRACT

An apparatus and method generating an optimal output. The apparatus includes at least a processor and a memory communicatively connected to the at least a processor. The memory instructs the processor to receive a plurality of reference data from an entity input, receive at least an inquiry datum associated with the plurality of reference data from the entity input, train, using entity training data, a first optimizer, generate, using the first optimizer, an optimal output as a function of the at least an inquiry and the plurality of reference data, receive, using the at least a processor, entity feedback comprising at least a correction datum, retrain, using the entity feedback, the first optimizer, display, using a downstream device, the optimal output through a graphical user interface of the downstream device.

### CROSS-REFERENCE TO RELATED APPLICATIONS

This application claims the benefit of priority of U.S. Provisional patent application Ser. No. 63/686,237, filed on Aug. 23, 2024, and titled “APPARATUS AND METHOD FOR RESOURCE MATRIX OPTIMIZER,” which is incorporated by reference herein in its entirety.

### FIELD OF THE INVENTION

The present invention generally relates to the field of artificial intelligence. In particular, the present invention is directed to an apparatus and a method generating an optimal output.

### BACKGROUND

Artificial intelligence (AI) technologies are rapidly evolving and being integrated into various aspects of resource optimization. However, many entities struggle to effectively leverage AI for short term and long-term planning related to resource optimization. Traditional resource optimization approaches often lack the ability to quickly process and analyze large amounts of data, identify emerging trends, and provide real-time insights.

### SUMMARY OF THE DISCLOSURE

In an aspect, an apparatus generating an optimal output includes at least a processor and a memory communicatively connected to the at least a processor. The memory contains instructions configuring the processor to receive a plurality of reference data from a user device, receive at least an inquiry datum associated with the plurality of reference data from the user device, classify, using the at least a processor, the at least an inquiry datum into one or more categories of a plurality of categories, generate, using a prompting model, a prompt in response to the at least an inquiry datum, wherein generating the prompt is a function of the at least an inquiry datum, the plurality of reference data, and the one or more categories, receive, using the at least a processor, return data associated with the prompt from the user device, generate, using an aggregate model, an optimal output, wherein generating the optimal output comprises aggregating the return data and the plurality of reference data, identifying key data from the aggregated data, and generating the optimal output as a result of the identified key data, and display, using a user interface, the optimal output.

In another aspect, a method generating an optimal output includes receiving, using at least a processor, a plurality of reference data from an entity input, receiving at least an inquiry datum associated with the plurality of reference data from the entity input, training, using entity training data, a first optimizer, wherein the first optimizer comprises at least a large language model, generating, using the first optimizer, an optimal output as a function of the at least an inquiry and the plurality of reference data, receiving, using the at least a processor, entity feedback comprising at least a correction datum, retraining, using the entity feedback, the first optimizer, and displaying, using a downstream device, the optimal output through a graphical user interface of the downstream device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an apparatus generating an optimal output;

FIG. 2 is a block diagram of an exemplary machine-learning process;

FIG. 3 is a diagram of an exemplary embodiment of a neural network;

FIG. 4 is a diagram of an exemplary embodiment of a node of a neural network;

FIG. 5 is an exemplary embodiment of a graphical user interface displaying a dashboard;

FIG. 6 is an exemplary embodiment of a graphical user interface displaying a dashboard;

FIG. 7 is a block diagram of an exemplary method generating an optimal output; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods generating an optimal output. The apparatus includes at least a computing device comprised of a processor and a memory communicatively connected to the processor. The memory instructs the processor receives a plurality of reference data from a user device, receives at least an inquiry datum associated with the plurality of reference data from the user device, classifies, using the at least a processor, the at least an inquiry datum into one or more categories of a plurality of categories, generates, using a prompting model, a prompt in response to the at least an inquiry datum, wherein generating the prompt is a function of the at least an inquiry datum, the plurality of reference data, and the one or more categories, receives, using the at least a processor, return data associated with the prompt from the user device, generates, using an aggregate model, an optimal output, wherein generating the optimal output comprises aggregating the return data and the plurality of reference data, identifying key data from the aggregated data, and generating the optimal output as a result of the identified key data, and displays, using a user interface, the optimal output.

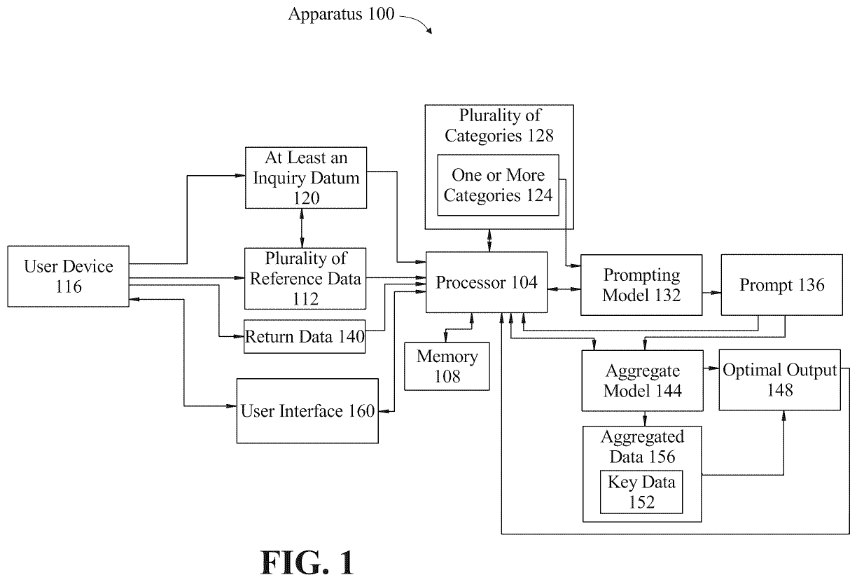

Referring now to FIG. 1, an exemplary embodiment of apparatus 100 generating an optimal output 148 is illustrated. Apparatus 100 may include a processor 104 communicatively connected to a memory 108. As used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 108 may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor 104. In one or more embodiments, data is transferred from secondary to primary memory wherein processor 104 may access the information from primary memory.

Still referring to FIG. 1, apparatus 100 may include a database. The database may include a remote database. The database may be implemented, without limitation, as a relational database, a key-value retrieval database such as a NOSQL database, or any other format or structure for use as database that a person skilled in the art would recognize as suitable upon review of the entirety of this disclosure. The database may alternatively or additionally be implemented using a distributed data storage protocol and/or data structure, such as a distributed hash table or the like. The database may include a plurality of data entries and/or records as described above. Data entries in database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database may store, retrieve, organize, and/or reflect data and/or records.

With continued reference to FIG. 1, apparatus 100 may include and/or be communicatively connected to a server, such as but not limited to, a remote server, a cloud server, a network server and the like. In one or more embodiments, the computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by the apparatus computing device. In one or more embodiments, computing device may transmit processes to server wherein computing device may conserve power or energy.

Further referring to FIG. 1, apparatus 100 may include any “computing device” as described in this disclosure, including without limitation a microcontroller, microprocessor, digital signal processor (DSP) and/or system on a chip (SoC) as described in this disclosure. Apparatus 100 may include, be included in, and/or communicate with a mobile device such as a mobile telephone or smartphone. Apparatus 100 may include a single computing device operating independently, or may include two or more computing devices operating in concert, in parallel, sequentially or the like; two or more computing devices may be included together in a single computing device or in two or more computing devices. Apparatus 100 may interface or communicate with one or more additional devices as described below in further detail using a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices. Apparatus 100 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 104 may receive a plurality of reference data 112 from an entity input. As used in this disclosure, “reference data” refers to data that serves as a basis or standard for comparison, analysis, or decision-making within the context of the resource matrix optimization. The reference data 112 can include historical data, industry benchmarks, performance metrics, financial records, operational data, and any other relevant information that can be used to inform and guide the optimization process. As used in this disclosure, “entity input” is the data or information provided by an entity. In an embodiment, the entity may include a business, organization, individual, and the like. In a non-limiting example, entity input may be used as an input for the resource matrix optimization process. The entity input can include specific inquiries, questions, or data points related to the entity's operations, goals, challenges, and other relevant aspects that need to be addressed or optimized by the apparatus 100 and method described in this disclosure. In an embodiment, the entity input may include structured or unstructured content that captures operational and strategic information relevant to an organization. The entity input may be received through manual entry or automated ingestion, and may reflect the context of a user's role, responsibilities, or department-specific initiatives. Without limitation, the entity input may include specific inquiries about aligning team objectives with organizational key performance indicators (KPIs), identifying delays in business plan milestones, or responding to recent company-level changes such as a merger or leadership transition. The input may also reflect operational pain points, such as declining customer satisfaction metrics or sales pipeline bottlenecks. In another non-limiting example, a marketing lead may provide entity input related to conversion rates and campaign return on investment (ROI), while a product manager may submit questions concerning feature prioritization based on usage analytics. An executive user may input high-level goals associated with investor relations, regulatory compliance, quarterly financial performance, and the like. Without limitation, a founder of a growing startup may provide inputs related to upcoming fundraising deadlines, evolving team structure, partnership opportunities, and the like.

Still referring to FIG. 1, the at least a processor 104 receives a plurality of reference data 112 from a user device 116. As used in this disclosure, a “user device” is an electronic device that is operated by or otherwise associated with an end user, and that is capable of communicating with one or more other devices, systems, or networks. A user device 116 may include, without limitation, a smartphone, tablet, laptop computer, desktop computer, wearable device, augmented reality headset, smart speaker, or any other computing device with data processing and communication capabilities. A user device 116 may include input components like touchscreen, keyboard, microphone, output components such as display, speaker, and the like, and communication interfaces (e.g., Wi-Fi, Bluetooth, cellular radio) to facilitate interactions between the end user and remote systems or services. As used in this disclosure, a “user” is an individual or entity that interacts with, operates, or is the intended recipient of services, functions, or data provided by a system, application, or device. A user may initiate commands, input data, receive outputs, or otherwise engage with a system through one or more user devices 116. A user may be authenticated or unauthenticated, and may include human operators, system administrators, or automated agents acting on behalf of a person or organization.

With continued reference to FIG. 1, apparatus 100 may include a central repository configured to receive the plurality of reference data 112, process the plurality of reference data 112, and store the plurality of reference data 112. As used in this disclosure, a “central repository” is a centralized storage system designed to collect, process, and store a plurality of reference data 112. Without limitation, the central repository may serve as a single source of truth, ensuring that all relevant data is accessible, organized, and maintained in a consistent manner. The central repository can be implemented using various database technologies, such as relational databases, NoSQL databases, or distributed data storage systems, and is configured to support efficient data retrieval and management for the optimization process. In an embodiment, the central repository may be configured to normalize and validate the incoming reference data 112 prior to storage, allowing downstream processes to operate on clean and reliable datasets. Without limitation, the reference data 112 may include historical records, baseline performance benchmarks, entity profile attributes, business rule parameters, domain-specific taxonomies, or metadata used in optimization routines. In another non-limiting example, the central repository may be implemented using a relational database such as Structured Query Language (SQL), a non-relational database such as a Not Only SQL (NoSQL) database, or a distributed file system such as the Hadoop Distributed File System (HDFS). In an embodiment, the central repository may support real-time queries, batch processing workflows, and data lineage tracking to ensure traceability and reproducibility of optimization outcomes. Without limitation, the central repository may be accessible by multiple computing components, including but not limited to, inference engines, orchestration models, or feedback processing components, enabling efficient access to reference data 112 during computation, analysis, and model training processes. In an embodiment, the central repository may also support data versioning, audit trails, and access control policies to meet enterprise-grade data governance and security requirements.

With continued reference to FIG. 1, entity input may further include a visual identifier to prepopulate the input field. As used in this disclosure, a “visual identifier” is a graphical element or symbol recognized by a device to trigger a specific digital action or process. Visual identifiers may include QR codes, barcodes, data matrices, or other scannable graphics that direct users to digital content, websites, or applications. As used in this disclosure, a “QR code” (Quick Response code) is a type of matrix barcode that can be scanned to quickly access information or websites. The QR code may be scanned using a using a smartphone, QR code reader, and the like. The QR codes may include of black squares arranged on a white grid, which encode data such as URLs, text, or contact information. When scanned, the QR code may direct the device to perform a specific action, such as opening a webpage or displaying content. Without limitation, the visual identifier may serve as a bridge between the physical and digital worlds, enabling users to access additional information or interactive content by using devices such as smartphones or tablets. Continuing, visual identifiers may be utilized in various contexts, such as marketing materials, educational resources, and product packaging, to enhance user engagement and facilitate seamless access to relevant digital experiences. For example, the QR code may prepopulate the input field with a prompt 136 related to the chapter that a user is reading and or example in the book. In a non-limiting example, an executive may be preparing for a quarterly strategic review meeting. Continuing, the executive's company may use a specialized AI tool that incorporates retrieval-augmented generation (RAG) to optimize resource allocation. Continuing, the executive receives a printed report that includes a QR code on the cover page. Continuing, when the executive scans the QR code with a smartphone, the device automatically prepopulates the input field of the AI tool with a prompt 136 related to the specific strategic goals and performance metrics outlined in the report. This seamless integration allows the executive to quickly access relevant data and insights, enabling them to make informed decisions during the meeting. The QR code may serve as a bridge between the physical report and the digital AI tool, enhancing the executive's ability to leverage the company's collective knowledge and AI capabilities.

With continued reference to FIG. 1, processing the reference data 112 may include normalizing the plurality of reference data 112 and generating a plurality of processed data using the plurality of reference data 112. As used in this disclosure, “processed data” is data that has been transformed or manipulated from its raw form into a format that is suitable for analysis and optimization. In a non-limiting example, the transformation may include steps such as normalization, cleaning, aggregation, and feature extraction, among others. Processed data may be used by the first optimizer and the second optimizer to generate insights, recommendations, or decisions that are more accurate and relevant to the entity's specific needs and objectives.

With continued reference to FIG. 1, apparatus 100 may be further configured to utilize retrieval-augmented generation to generate the optimal output 148. As used in this disclosure, “retrieval-augmented generation (RAG)” is a technique that combines the strengths of information retrieval and generative models to produce more accurate and contextually relevant outputs. In a non-limiting example, the retrieval process may involve querying a central repository or database to gather pertinent data points related to the inquiry datum 120 and the plurality of reference data. Continuing, this repository may contain historical data, performance metrics, industry benchmarks, and other relevant information that may provide a comprehensive context for the optimization process. Without limitation, the retrieved information may include specific data points, documents, or records that are directly relevant to the entity's needs and objectives. In a non-limiting example, a company may use a retrieval-augmented generation system to enhance its internal performance review process. The RAG system may be configured to query the company's central HR database to pull relevant information such as employee performance metrics, historical review documents, and departmental objectives. Continuing, the RAG may retrieve and aggregate data points like key performance indicators (KPIs), feedback from previous reviews, and peer evaluations. Continuing, the retrieved information could then be used to auto-generate a performance review template that is customized for each employee, containing specific data and insights tailored to their role, performance history, and development goals. Without limitation, this process may include querying databases for additional templates, such as goal-setting forms or self-assessment documents, ensuring that all documents reflect up-to-date and comprehensive information. In another non-limiting example, a company may use a RAG system to streamline its sales proposal creation process. The RAG system may be configured to pull relevant data from the company's customer relationship management (CRM) database, financial records, and previous proposals. Continuing, the system may retrieve data points such as client preferences, historical pricing information, and successful sales strategies. Continuing, the retrieved information could be used to auto-generate a customized sales proposal template for a specific client, incorporating tailored pricing options, product details, and personalized messaging. Without limitation, the system may also retrieve and populate other relevant templates, such as contract agreements and follow-up communication plans, ensuring that all materials are aligned with the client's history and the company's sales goals.

In a non-limiting example, a company may use a RAG system to incorporate personality profiles to further enhance its internal processes. Continuing, the RAG system may be configured to query the company's HR database, gathering not only performance metrics and historical review data but also personality assessments, such as results from psychometric tests or behavioral evaluations. Continuing, the RAG system may use the personality profile data to better tailor performance review templates to each employee's individual communication style, motivational drivers, leadership potential, and the like. Continuing, this personalized approach may lead to more effective feedback and development plans. In another non-limiting example, the personality profile data retrieved by the RAG system may be applied to the sales proposal creation process. By integrating information from personality profiles of both the sales team members and the clients, the RAG system could suggest strategies and communication styles best suited to each client. Continuing, this may influence the tone and structure of the sales proposal, making it more likely to resonate with the client's preferences and decision-making style. Without limitation, this process may also involve generating follow-up communication plans that align with the client's personality, enhancing relationship management and customer satisfaction.

In a non-limiting example, a company may utilize the RAG system to create strategic plans by pulling and analyzing data from various internal and external sources. Continuing, the RAG system may retrieve historical business performance data, market trends, competitor analysis, and industry forecasts from the company's databases and external resources. Continuing, the RAG system may generate a strategic plan tailored to the company's long-term vision, proposing key objectives, initiatives, and timelines. Continuing, this strategic plan may be tested against different long-term scenarios to evaluate potential outcomes and refine the company's overall direction. In another non-limiting example, the RAG system may compare the newly created strategic plan with the company's existing long-term vision, ensuring alignment with broader corporate goals. Without limitation, the RAG system may highlight discrepancies or areas where the strategy may need adjustment to stay on track with the company's long-term objectives.

Additionally and or alternatively, in another non-limiting example, the RAG system may assist with quarterly strategy reviews by retrieving and analyzing up-to-date performance metrics, market conditions, progress reports, and the like. Without limitation, the RAG system may then generate insights and recommendations for refining the strategy, helping the company stay agile and responsive to changing conditions while maintaining alignment with its long-term goals.

Continuing, once the relevant information is retrieved, it may be fed into a generative model like a large language model (LLM), such as the first optimizer. Continuing, the generative model may use this information to generate the optimal output 148, ensuring that the output is not only accurate but also contextually relevant. Continuing, the generative model may process the retrieved information along with the inquiry datum 120 and the plurality of reference data 112 to produce a tailored solution or recommendation that addresses the specific needs of the entity. Continuing, the retrieved information may serve as a critical input to the generative model, providing the necessary context and background to generate a high-quality output. By leveraging the strengths of both information retrieval and generative models, RAG may produce outputs that are more precise and aligned with the entity's goals. This approach ensures that the generated output is grounded in real-world data and is relevant to the specific context in which it will be used. In some embodiments, retrieval augmented generation may include retrieving a decision-making process. In some embodiments, this may include retrieving a decision-making process from a database. In some embodiments, decision-making process may include a 7-step decision-making process. In some embodiments, decision-making process may include a decision-making process for implementing AI in a business. In some embodiments, decision-making process may include a 7-step decision-making process for implementing AI in a business. In some embodiments, information retrieved as part of retrieval augmented generation may be input into a large language model. As a non-limiting example, input into LLM may include “answer [user prompt] in accordance with [decision-making process].”

In a non-limiting example, relevant information may be first retrieved from a large dataset or knowledge base, and this retrieved information is then used to inform and guide the generation process. Continuing, this method may enhance the quality and relevance of the generated output by grounding it in specific, contextually appropriate data. For instance, without limitation, in the context of conducting performance reviews, the retrieval-augmented generation technique can be used to pull relevant performance metrics, feedback, and historical data from the central repository. Continuing, this retrieved information may then be used to generate a comprehensive and tailored performance review for an employee. Continuing, by grounding the review in specific data points and historical context, the optimal output 148 is more accurate and relevant, providing actionable insights for both the employee and the reviewer. In another non-limiting example, involving strategic planning for a business, when creating a strategic plan, the retrieval-augmented generation technique may retrieve relevant market trends, financial data, and previous strategic decisions from the central repository. Continuing this information may then be used to generate a strategic plan that is informed by historical context and current market conditions. Continuing, the generated plan may be more likely to be effective and aligned with the business's goals and challenges. In another non-limiting example, in the context of preparing for board meetings, the retrieval-augmented generation technique may be used to gather relevant information about board members, previous meeting minutes, and key performance indicators. Continuing, this technique may streamline the preparation process by automatically pulling together all necessary data points. For instance, the system may retrieve historical data on board members' attendance, contributions, and voting patterns, providing a comprehensive overview of each member's involvement. Continuing, without limitation, this may be particularly useful for new board members or executives who need to quickly get up to speed on the board's dynamics and history. Continuing, this retrieved information may then be used to generate pre-meeting briefs and post-meeting summaries that are tailored to the specific needs and interests of the board members. In a non-limiting example, the pre-meeting briefs may include personalized agendas, highlighting topics of particular interest to each board member based on their past interactions and stated preferences. For example, without limitation, if a board member has shown a keen interest in financial performance, the brief could emphasize recent financial reports and projections. Continuing, this level of customization could make meetings more efficient and focused, as each member would be better prepared to discuss the issues most relevant to them. In another non-limiting example, the post-meeting summaries may provide a detailed account of the discussions and decisions made, along with action items assigned to each board member. Continuing, these summaries may include links to relevant documents, such as updated strategic plans or financial statements, making it easier for board members to follow up on their responsibilities. Additionally and or alternatively, the retrieval-augmented generation technique may be used to analyze the effectiveness of past meetings and suggest improvements for future ones. For instance, without limitation, the system may identify patterns in the data, such as topics that consistently lead to lengthy discussions or decisions that are frequently revisited. Continuing, this analysis may help the board chair to structure future meetings more effectively, perhaps by allocating more time to contentious issues or by providing additional background information on complex topics. In another non-limiting example, the system may facilitate better communication and collaboration between board members outside of formal meetings. For instance, without limitation, the system may include a centralized repository for meeting minutes, performance indicators, and other relevant documents. Continuing, the system may make it easier for board members to stay informed and engaged. Without limitation, this may provide value for boards that meet infrequently or have members who are geographically dispersed.

In some embodiments, an LLM module may be configured to interface with the retrieval-augmented generation system to enhance its functionality, particularly for applications involving complex decision-making processes. Continuing, the RAG system may serve as a dynamic knowledge base that the LLM can access to retrieve specific information relevant to a user's query. This information may include a structured decision-making process or an AI matrix designed to guide users through multi-step processes. The LLM may leverage external, structured data sources, by using the RAG system thereby allowing the LLM to generate more precise and contextually relevant outputs. For example, without limitation, when a user queries the system for advice on AI integration into their business, the LLM may access the RAG system to provide detailed guidance based on a predefined 7-step decision-making framework. This integration ensures that the LLM not only relies on its pre-trained knowledge but also supplements its responses with up-to-date, contextual information, thereby enhancing the accuracy and utility of the generated content.

Still referring to FIG. 1, processor 104 may receive at least an inquiry datum 120 associated with the plurality of reference data 112 from the entity input. As used in this disclosure, an “inquiry datum” is a specific piece of information or a question provided by an entity that is associated with the plurality of reference data 112. The term “inquiry datum” may also be referred to interchangeably herein as an inquiry, a user inquiry, a question, or a request. This datum is used to guide the optimization process by specifying particular aspects or areas of interest that need to be addressed. The inquiry datum 120 helps in tailoring the optimization output to meet the specific needs or objectives of the entity. For example, the inquiry may be “how should I integrate AI into my business next,” “what is the next step in my AI decision making process,” “what is my AI readiness score,” and/or “what trainings should I undertake to prepare for AI integration.”

Still referring to FIG. 1, the at least a processor 104 receives at least an inquiry datum 120 associated with the plurality of reference data 112 from the user device 116. Without limitation, the inquiry datum 120 may represent a user-initiated question, request, or command that is contextually related to the previously transmitted reference data 112. For example, without limitation, the inquiry datum 120 may seek clarification, guidance, or a specific type of output based on the contents of the reference data 112. In a non-limiting example, the inquiry datum 120 could be a natural language question directed at deriving a summary or recommendation based on the reference materials. The association between the inquiry datum 120 and the reference data 112 allows the processor 104 to interpret user intent with greater contextual understanding, enabling downstream processing such as classification and prompt generation. Without limitation, the inquiry datum 120 may reflect a strategic question aimed at optimizing operations, identifying growth opportunities, or assessing organizational performance. For example, without limitation, a CEO may submit an inquiry such as “What are the key drivers behind last quarter's revenue dip across regions?” in the context of previously submitted sales data, customer engagement metrics, and internal reports. In a non-limiting example, an executive may request, “Based on current market signals and internal performance trends, where should we allocate additional resources in Q4?” The ability of the apparatus 100 to interpret such leadership-driven inquiries in relation to the reference data 112 allows for rapid generation of context-aware, optimized outputs that can inform high-stakes decisions without requiring manual data synthesis by support teams.

Still referring to FIG. 1, the at least a processor 104 classifies the at least an inquiry datum 120 into one or more categories 124 of a plurality of categories 128. As used in this disclosure, a “category” is a classification label that represents a thematic, functional, or contextual grouping used to organize or interpret data. In an embodiment, the data that is classified may include the inquiry data. The category may correspond to a particular domain, such as finance, operations, or marketing, an analytical intent, such as forecasting, benchmarking, anomaly detection, and the like, or a business function, such as executive reporting, strategic planning, customer insights, and the like. In an embodiment, the category is applied to an inquiry datum 120 to guide the logic of processing steps. This may enable the apparatus 100 to tailor response generation, prompt formation, and data aggregation in a manner that is aligned with the subject matter and business context associated with the inquiry. Without limitation, the classification process may allow the apparatus 100 to determine the subject matter, intent, or domain relevance of the inquiry datum 120, which in turn guides subsequent stages of processing, such as prompt generation or the aggregation of contextually relevant data. For example, without limitation, an inquiry such as “What is our projected operating margin for the next quarter?” may be classified into categories 124 such as financial forecasting, executive reporting, or revenue optimization. In a non-limiting example, an inquiry like “Where should we invest additional resources to improve customer retention?” may be categorized under customer analytics, resource planning, or strategic growth.

With continued reference to FIG. 1, the classification may be performed using machine learning models trained to assign one or more category labels to input text data. In an embodiment, a natural language classification model may be utilized. Without limitation, this may include models based on supervised learning algorithms such as support vector machines, random forest classifiers, or multilayer perceptrons. In more advanced implementations, the apparatus 100 may employ deep learning architectures, such as transformer-based models that have been fine-tuned to perform text classification tasks across enterprise-specific datasets. In a non-limiting example, the apparatus 100 may use a fine-tuned version of a bidirectional encoder representation from transformers model to infer intent and assign categories 124 based on semantic similarity to labeled historical inquiries. Without limitation, the resulting category or categories 124 assigned to the inquiry datum 120 may enable the apparatus 100 to tailor its downstream processing with greater precision, ultimately contributing to the generation of an optimal output 148 that aligns with the executive or operational objectives reflected in the inquiry.

Still referring to FIG. 1, processor 104 may train, using entity training data, a first optimizer, wherein the first optimizer includes a first large language model. As used in this disclosure, “entity training data” refers to the data used to train the optimization model specific to the entity's context. This data can include historical performance data, operational metrics, financial records, and any other relevant information that can be used to teach the model how to generate optimal output 148 based on the entity's unique characteristics and requirements. As used in this disclosure, “first optimizer” refers to the initial at least a large language model or algorithm that is trained using the entity training data to generate optimal output 148. The first optimizer may process the inquiry datum 120 and the plurality of reference data 112 to produce an optimal output 148 tailored to the entity's specific needs. This optimizer can be a neural network, a regression model, or any other suitable at least a large language model.

Without limitation, entity training data may be unique for each company that uses the apparatus 100 and method generating an optimal output 148, as it is tailored to the specific operational metrics, historical performance data, and strategic goals of the individual entity. For instance, without limitation, a retail company might have entity training data that includes sales figures, inventory levels, customer demographics, and seasonal trends. In contrast, a manufacturing company may focus on production rates, supply chain logistics, equipment maintenance records, and quality control metrics. Without limitation, by incorporating these unique datasets, the first optimizer can be trained to generate outputs that are highly relevant to the specific needs and challenges of each company. This customization ensures that the optimizer model is not only accurate but also contextually appropriate for the entity's particular business environment. In a non-limiting example. training models specifically for different corporations involves a process of fine-tuning the machine learning algorithms to account for the unique characteristics and requirements of each entity. For example, without limitation, a financial services firm may require a model that emphasizes risk assessment, regulatory compliance, and investment performance, while a healthcare provider might need a model focused on patient outcomes, treatment efficacy, and resource allocation. The training process would involve feeding the model with entity-specific training data, allowing it to learn the unique patterns and correlations within that data. This may include supervised learning techniques where the model is trained on labeled datasets, as well as unsupervised learning methods to identify hidden patterns and insights. Continuing, by tailoring the training process to the specific needs of each corporation, the resulting AI model can provide more accurate and actionable recommendations, enhancing the company's ability to optimize its resources and achieve its strategic objectives.

Still referring to FIG. 1, processor 104 may generate, using the first optimizer, an optimal output 148 as a function of the at least an inquiry and the plurality of reference data 112. The optimal output 148 may be tailored to meet the specific needs or objectives of the entity, providing actionable insights, recommendations, or decisions that enhance the efficiency, effectiveness, or performance of the entity's operations. The optimal output 148 may be derived through the application of machine learning algorithms and is intended to represent the most favorable outcome given the input data and the defined optimization criteria.

Still referring to FIG. 1, the at least a processor 104 generates, using a prompting model 132, a prompt 136 in response to the at least an inquiry datum 120, wherein generating the prompt 136 is a function of the at least an inquiry datum 120, the plurality of reference data 112, and the one or more categories 124. As used in this disclosure, a “prompting model” is a data-driven or rule-based computational model configured to generate a prompt 136 in response to input data, such as an inquiry datum 120, reference data 112, or category labels. In an embodiment, the prompting model 132 may include, without limitation, a machine learning model, a large language model, or a template-based system designed to construct context-aware prompts that initiate or guide further data processing or user interaction. As used in this disclosure, a “prompt” is a generated textual or structured output that is designed to elicit a specific type of response, processing action, or user input, based on the context of an inquiry datum 120 and related data. A prompt 136 may take the form of a question, instruction, clarification request, or command, and serves as an intermediate artifact that bridges the user's inquiry with the response generation process of the apparatus 100.

Without limitation, the prompting model 132 may apply natural language generation techniques, rule-based decision logic, or learned prompt 136 structures to synthesize a context-aware prompt 136 that captures the underlying intent of the inquiry, clarifies ambiguities, or guides the apparatus 100 toward generating a contextually relevant output. In an embodiment, the prompting model 132 may be configured to evaluate the inquiry datum 120 in combination with the plurality of reference data 112 and one or more identified categories 124 to determine the most effective formulation of the prompt 136. For example, without limitation, if a user inquiry is categorized under financial forecasting and the reference data 112 comprises a series of historical sales reports, the prompting model 132 may be configured to generate a prompt 136 such as “Generate a projection for next quarter's revenue based on the provided sales history.” In a non-limiting example, the prompting model 132 may identify that the reference data 112 includes product-level sales data but lacks cost structure information, and may therefore generate a prompt 136 such as “What are the associated operating costs for each product category to complete margin forecasting?” For example, without limitation, where the user inquiry relates to organizational performance but the available reference data 112 only includes qualitative staff feedback and lacks quantitative key performance indicators, the prompting model 132 may construct a clarification prompt 136 such as “Please provide numerical performance metrics, such as monthly KPIs, for the current fiscal year to proceed with performance analysis.” In another non-limiting example, if the inquiry is broadly phrased as “How are we doing this quarter?” and the associated category is executive reporting, the prompting model 132 may synthesize a more structured version such as “Summarize financial performance, customer satisfaction metrics, and operational KPIs for the current quarter.” In all such cases, the generated prompt 136 may serve as an intermediary construct that enables the apparatus 100 to establish a targeted and meaningful link between the inquiry datum 120 and the underlying data environment. This intermediary step may facilitate the generation of an optimal output 148 that is aligned with the context, category, and intent of the inquiry.

With continued reference to FIG. 1, the prompt 136 may include a gap inquiry configured to elicit additional data, wherein the gap inquiry is associated with an identified gap in the plurality of reference data 112. As used in this disclosure, a “gap inquiry” is a question generated by the apparatus 100 and configured to elicit missing, incomplete, or underrepresented information from a user. A gap inquiry is generated in response to detecting an identified gap in the reference data 112 and is intended to improve the completeness, clarity, or accuracy of the data set used to generate an optimal output 148. As used in this disclosure, “additional data” is user-provided data that is received in response to a gap inquiry, and that supplements, enhances, or completes the plurality of reference data 112. Additional data may include, without limitation, structured data, unstructured text, numerical values, selections from predefined options, or file attachments. As used in this disclosure, an “identified gap” is a portion of the plurality of reference data 112 that is determined to be missing, insufficient, inconsistent, or contextually irrelevant for responding to a given inquiry datum 120. The identified gap may be determined by the apparatus 100 based on predefined rules, heuristics, semantic analysis, or machine learning-based pattern detection. In an embodiment, the identified gap may be determined by the apparatus 100 through one or more techniques that assess the sufficiency and relevance of the plurality of reference data 112 in relation to the inquiry datum 120. Without limitation, the apparatus 100 may apply predefined rules, such as required data fields or mandatory contextual inputs for a particular category of inquiry. For example, without limitation, if the inquiry pertains to financial forecasting, a rule may specify that historical revenue figures and cost breakdowns must be present. If those elements are absent, the apparatus 100 may flag a corresponding gap. n another embodiment, the apparatus 100 may utilize heuristics, which are domain-informed shortcuts or conditional checks designed to infer missing elements based on patterns observed in typical inputs. For example, without limitation, a heuristic may determine that when the inquiry includes the term “expansion strategy,” the reference data 112 should include market research or geographic feasibility inputs. If such data is not detected, the apparatus 100 may infer a likely gap. In an embodiment, semantic analysis may be applied to assess the meaning and context of both the inquiry datum 120 and the plurality of reference data 112. This may include, without limitation, analyzing the linguistic structure, identifying keywords, measuring semantic similarity, or detecting contradictions or omissions between the inquiry and the data. For example, without limitation, if the inquiry requests an environmental impact summary but the reference data 112 only discusses production metrics, semantic analysis may reveal that sustainability-related terms are absent, thereby indicating a contextual gap. In another embodiment, the apparatus 100 may employ machine learning-based pattern detection, such as anomaly detection models or classification algorithms trained on historical inquiry-response datasets. These models may learn to recognize typical data compositions associated with specific categories 124 of inquiries and may flag deviations from those patterns. For example, without limitation, a trained model may expect profit margin analysis inquiries to be accompanied by both revenue and cost of goods sold data. If only revenue data is present, the model may detect the absence of cost data as a statistically significant anomaly, thereby identifying a gap. Each of these techniques, whether applied independently or in combination, may allow the apparatus 100 to dynamically determine when additional data is needed to complete or clarify the context of the inquiry, thereby enabling more accurate and actionable responses. Without limitation, this functionality may enable the apparatus 100 to dynamically assess whether the reference data 112 provided by the user is sufficient to produce an optimal output 148. Upon detecting an identified gap, the prompting model 132 may generate a context-aware prompt specifically designed to obtain the missing information. For example, without limitation, if the user submits an inquiry such as “Generate a hiring plan for next quarter,” and the reference data 112 includes only projected growth figures without any current staffing levels, the apparatus 100 may generate a gap inquiry such as “Please provide current department-level headcount data to proceed with the hiring plan.” In a non-limiting example, if the inquiry requests an analysis of marketing campaign effectiveness but the reference data 112 lacks performance metrics such as conversion rates or engagement statistics, the apparatus 100 may generate a gap inquiry such as “Please include metrics on customer engagement or conversion performance for each campaign.” For example, without limitation, a CEO may inquire, “What is our readiness level for international expansion?” and the apparatus 100 may identify that geographic risk assessments are missing from the reference data 112. In response, a gap inquiry may be generated such as “Please provide recent risk assessments or market viability reports for the regions under consideration.” In another non-limiting example, if an executive asks, “How are we performing relative to industry benchmarks?” and the apparatus 100 identifies that competitor data is not present, a gap inquiry such as “Please provide relevant competitor performance data or industry benchmark reports” may be generated. These gap inquiries may serve a critical function in enabling the apparatus 100 to generate more complete and actionable outputs by prompting the user to close data gaps in a targeted manner. In an embodiment, the prompting model 132 may tailor each gap inquiry to reflect the precise nature of the identified gap and the domain of the inquiry, ensuring the interaction remains efficient and contextually relevant.

With continued reference to FIG. 1, the at least a processor 104 may be further configured to train the prompting model 132 with prompting training dataset, the prompting training dataset comprises historical prompts associated to historical inquiries. As used in this disclosure, a “prompting training dataset” is a dataset comprising a plurality of historical prompts and a plurality of corresponding historical inquiries, the prompting training dataset being configured to be used for training the prompting model 132 to generate prompts in response to new inquiry data. The prompting training dataset may include annotated examples, feedback signals, or contextual relationships between the historical prompts and the historical inquiries, thereby enabling the prompting model 132 to learn from prior interactions. As used in this disclosure, a “historical prompt” is a previously generated prompt that was issued in response to an inquiry datum 120 received from a user device 116. The historical prompt may include one or more instructions, questions, or gap inquiries configured to elicit additional data from the user device 116 in view of the received inquiry datum 120 and any associated reference data 112. As used in this disclosure, a “historical inquiry” is a previously received inquiry datum 120 associated with one or more sets of reference data 112, the historical inquiry being part of a prior interaction with the user device 116, and forming the basis upon which a historical prompt was generated by the prompting model 132. For example, without limitation, the prompting training dataset may include historical inquiries submitted by executives, such as “What is the projected ROI for the next product cycle?” and their corresponding historical prompts, such as “Please provide the expected unit sales volume and cost projections for the proposed product line.” These prompt-inquiry pairs may be used to train the prompting model 132 to anticipate and respond to future financial planning inquiries. In a non-limiting example, a historical inquiry such as “How should we prioritize international markets for entry?” may be paired in the prompting training dataset with a historical prompt like “Please identify current market penetration metrics, competitive landscape data, and logistical constraints for each candidate region.” This pairing allows the prompting model 132 to learn how to elicit strategic inputs relevant to global expansion decisions. In another non-limiting example, the prompting training dataset may include a sequence of historical inquiries related to workforce planning, such as “What adjustments are needed in headcount for Q1?” paired with historical prompts such as “Please upload department-level attrition rates and current headcount distribution.” These examples enable the prompting model 132 to recognize common data gaps associated with HR-driven strategic planning. For example, without limitation, in cases involving operational performance review, a historical inquiry such as “What is driving the decline in operational efficiency this quarter?” may be linked to a prompt 136 like “Please provide updated throughput metrics and system downtime reports for the relevant production lines.” The prompting model 132 may use such historical pairings to develop heuristics for identifying common missing data in performance diagnostics.

With continued reference to FIG. 1, in an embodiment, the optimal output 148 may include a context-sensitive prompt. As used in this disclosure, a “context-sensitive prompt” is information generated by a computing system that dynamically reflects the current state, conditions, or attributes associated with a particular user, role, entity, or operational environment. Without limitation, the “context-sensitive prompt” may be referred to simply as the “prompt.” The context-sensitive prompt may be tailored to align with specific contextual inputs, such as organizational role, key performance indicators (KPIs), team objectives, recent business events, behavioral patterns, and the like. In an embodiment, the information used to generate a context-sensitive prompt, such as behavioral patterns, recent business events, organizational role, key performance indicators (KPIs), and team objectives may be derived from the entity input. For example, without limitation, if a user is a sales manager (organizational role), the prompt 136 may reference sales goals or pipeline updates. In another non-limiting example, if the user's key performance indicators (KPIs) show they are falling behind on revenue targets, the prompt 136 may ask what support or resources they need. In another non-limiting example, if a user's behavioral pattern indicates missed deadlines or reduced engagement, the prompt 136 may ask about obstacles or suggest prioritization strategies. In an embodiment, a context-sensitive prompt may be automatically generated in response to detecting that a user has taken on a new responsibility, missed a milestone, shown declining performance in a tracked metric, and the like. Without limitation, the context-sensitive prompt may include questions, suggestions, or strategic guidance that directly pertain to the user's real-time situation. In another non-limiting example, the context-sensitive prompt may ask a team leader, “How are you adjusting your resource plan in light of the Q3 hiring freeze?” or may suggest a next step like, “Review updated product roadmap before Friday's stakeholder meeting.” The context-sensitive prompts may be designed to support timely decision-making, personalized coaching, and/or proactive intervention, leveraging current data inputs and user-specific variables to ensure relevance and impact. In an embodiment, the context-sensitive prompt may be tailored to a user's specific role, responsibilities, and/or organizational dynamics.

With continued reference to FIG. 1, in an embodiment, the optimal output 148 may be generated using a context-aware prompting engine. As used in this disclosure, a “context-aware prompting engine” is information processing functionality configured to generate prompts that are dynamically tailored. Without limitation, the “context-aware prompting engine” may be referred to as the “prompting engine” herein. Without limitation, the context-aware prompting engine may generate tailored prompts based on real-time or historical context associated with an entity. The context-aware prompting engine may use structured and unstructured entity input, such as organizational role, performance metrics, team objectives, recent changes, and the like, to deliver prompts that are relevant, timely, and aligned with the user's situational needs. In an embodiment, the context-aware prompting engine may use a combination of data pipelines, rule-based logic, machine learning models, and the like, to process incoming entity input and determine when and how to generate a prompt 136. Without limitation, the context-aware prompting engine may incorporate event-driven architecture to respond to triggers such as missed milestones or a change in user responsibilities. The context-aware prompting engine may employ scheduling logic that respects user-defined cadences or adapts dynamically based on user responsiveness. In another non-limiting example, the context-aware prompting engine may use retrieval-augmented generation (RAG), wherein it queries a central repository or vector database to retrieve relevant data points that inform the prompt 136 content. The prompt 136 may then be composed or rephrased using a large language model (LLM), optionally fine-tuned with persona-based inputs or tone guidelines derived from user preferences, psychometric assessments, or organizational culture. In an embodiment, the context-aware prompting engine may be implemented using cloud-based infrastructure, natural language processing (NLP) components, and role-based access control (RBAC) to ensure secure and scalable deployment across multiple users and departments. This configuration may allow the apparatus 100 to support secure, intelligent, and scalable deployment across multiple users and departments. Without limitation, cloud-based infrastructure may enable the apparatus 100 to process large volumes of entity input in real time, while NLP components may allow the apparatus 100 to generate prompts in natural, user-specific language. RBAC may ensure that prompt delivery and access to context-sensitive data are restricted based on each user's assigned role, maintaining data integrity and confidentiality throughout the system. The context-aware prompting engine may be configured to automatically generate prompts as a function of real-time or historical entity input, including without limitation, the user's role, team goals, key performance indicators (KPIs), business plan milestones, recent company-level changes, and the like. Without limitation, the prompting engine may detect contextual shifts, such as the assignment of a new role or an update in responsibilities, and may respond by generating a relevant prompt 136 for the user. In an embodiment, the prompt 136 may address user-specific performance factors. For example, without limitation, if the user has not met a performance threshold or has failed to achieve alignment with strategic objectives, the context-aware prompting engine may generate a prompt 136 that initiates targeted reflection or planning. In another non-limiting example, the prompt 136 may ask questions such as, “What challenges have impacted your recent KPI attainment?” or “How have you adapted to your new leadership role?”

With continued reference to FIG. 1, in a non-limiting example, prompting engine may be consistent with one or more aspects of the prompting engine described in U.S. patent application Ser. No. 19/305,258, filed on Aug. 20, 2025, titled “APPARATUS AND METHOD FOR GENERATING CONTEXT-AWARE DEVICE PROMPTS AND TRANSMISSION PROTOCOLS,” which is incorporated by reference herein in its entirety.

With continued reference to FIG. 1, in an embodiment, the prompting engine may be trained using one or more reinforcement learning algorithms. As used in this disclosure, a “reinforcement learning algorithm” is a type of machine learning technique in which an agent learns to make decisions by interacting with an environment, taking actions, and receiving feedback in the form of a reward signal. Without limitation, the agent's objective is to optimize its behavior over time by maximizing the cumulative reward. Without limitation, the environment may include contextual inputs, user interactions, performance data, or other observable states, while the actions may include selecting prompts, determining delivery times, or choosing communication channels. In an embodiment, the reinforcement learning algorithm may use a policy. As used in this disclosure, a “policy” is a computational strategy or decision-making function used by a learning agent to determine which action to take in a given state of the environment. Without limitation, a policy may map contextual inputs, like entity input such as user behavior, time of day, performance indicators, delivery history, and the like, to corresponding outputs, such as a prompt 136, communication channel, or delivery schedule. The policy may include a strategy that defines the agent's behavior as a mapping from observed states to selected actions. The policy may be learned through repeated interaction with the environment, guided by trial-and-error exploration and reward evaluation. In another non-limiting example, the agent may begin training using a set of expert demonstrations, also known as “expert actions,” to accelerate convergence toward optimal decision-making. Without limitation, the reward signal may be derived from user engagement metrics, such as response rate, task completion, or sentiment analysis, enabling the reinforcement learning algorithm to improve the prompting engine's performance over time. Without limitation, the prompting engine may adaptively refine prompt 136 selection and timing based on user interactions and feedback. Without limitation, reinforcement learning is a machine learning technique in which an agent learns to make decisions by interacting with an environment and maximizing a defined reward signal or scoring function. In an embodiment, the prompting engine may incorporate a policy-based reinforcement learning approach, where a policy constrains the agent's behavior by mapping observed conditions to optimal actions. The policy may initially be derived from expert-curated prompts and further optimized through iterative learning cycles. Without limitation, the prompting engine may be trained using historical data such as user engagement metrics, response times, follow-through actions, and sentiment scores derived from natural language processing of responses. In another non-limiting example, the prompting engine may use reinforcement signals based on improvements in user KPIs, goal attainment, or behavioral alignment following the delivery of a prompt 136. In an embodiment, these feedback loops may guide the prompting engine toward selecting prompt 136 types, delivery channels, and delivery times that maximize engagement and effectiveness. In an embodiment, the prompting engine may be trained using real-time and historical performance data combined with user-specific behavioral traits and persona preferences. For example, if a user characterized by a DISC profile as a “quick-start dominant” persona tends to respond better to action-oriented prompts delivered using mobile push notifications in the morning, the prompting engine may learn to increase the frequency of similar prompts at that time and through that channel. In another non-limiting example, if the user consistently ignores prompts sent on Friday afternoons, the prompting engine may learn to deprioritize that time slot for future messaging. Accordingly, the use of reinforcement learning may allow the prompting engine to continuously evolve and personalize its behavior across users, roles, and organizational settings, enhancing its ability to deliver timely and contextually relevant prompts that drive alignment and action.

With continued reference to FIG. 1, in an embodiment, the prompts may be delivered through various user-facing channels, allowing for flexible and context-appropriate communication that aligns with user preferences and work environments. Without limitation, the context-aware prompting engine may send messages through team collaboration platforms such as Slack, enabling real-time interactions within the user's existing workflow. In another non-limiting example, the prompts may be delivered using email, allowing users to reflect on the prompt 136 content asynchronously or incorporate responses into longer-form reporting or planning. In an embodiment, SMS text messages or mobile push notifications may be used to deliver concise and time-sensitive prompts directly to a user's personal device, ensuring that critical insights are accessible even when the user is away from their desktop. Without limitation, prompts may also appear as calendar reminders, prompting reflective actions or check-ins at predefined intervals or in advance of scheduled events such as team reviews or strategy meetings. In another non-limiting example, prompts may be embedded directly within dashboards used by the organization, ensuring seamless visibility alongside performance metrics, task trackers, workflow systems, and the like. This multi-channel delivery approach may allow the apparatus 100 to maximize user engagement, minimize friction, and ensure that prompts are received in the most effective format for the user's context. Without limitation, the user may configure a cadence for receiving prompts, such as on a daily or weekly basis. In an embodiment, the prompting engine may adapt this cadence based on user responsiveness, increasing the frequency for disengaged users or scaling back for users demonstrating consistent follow-through. In another non-limiting example, the prompt 136 may be shaped by the user's preferred persona, such as a “visionary founder,” “no-nonsense chief operating officer (COO),” or “future self” In an embodiment, the prompting engine may adapt tone, phrasing, or motivational framing using personality inputs, including but not limited to DISC assessment data or Kolbe index profiles. This configuration may leverage “Persona” structures. As used in this disclosure, “Persona structures” are models that define how prompts are shaped, styled, and delivered in alignment with a user's preferred communication tone, motivational framing, and behavioral attributes. A Persona structure may include parameters such as linguistic style, emotional tone, goal orientation, and the like, and may be informed by psychometric assessments, user preferences, role-based archetypes, and prior interaction history. In an embodiment, a Persona structure may be selected or configured by the user to reflect a desired mindset or leadership identity. Without limitation, examples may include personas such as “visionary founder,” “no-nonsense chief operating officer (COO),” or “future self” Each persona may influence how prompts are phrased, including the use of assertive versus reflective language, the inclusion of motivational cues, or the prioritization of strategic versus tactical focus. In another non-limiting example, a Persona structure may incorporate psychometric indicators derived from assessments such as DISC, Kolbe, and the like, allowing the apparatus 100 to align prompts with the user's dominant behavioral patterns. As used in this disclosure, “DISC” and “Kolbe” are standardized psychometric assessment tools designed to measure different aspects of human behavior and cognitive style. These assessments may be used to inform Persona structures for tailoring prompts in a manner that aligns with the user's communication preferences and decision-making tendencies. In an embodiment, the DISC assessment is a behavioral profiling system that categorizes individuals into four primary styles: Dominance, Influence, Steadiness, and Conscientiousness. Without limitation, someone with a high Dominance score may prefer direct, results-oriented language, while someone with high Steadiness may respond better to supportive, stability-focused communication. In another embodiment, the Kolbe Index measures a person's instinctive problem-solving approach, particularly their conative strengths, such as how they take action when free to do things their own way. The Kolbe A Index, for example, evaluates four action modes: Fact Finder, Follow Thru, Quick Start, and Implementor. Without limitation, a high Quick Start user may prefer visionary, exploratory prompts, while a high Follow Thru user may respond better to structured, step-by-step guidance. In an embodiment, the results of psychometric assessments such as the DISC assessment and the Kolbe Index may be received as part of the entity input. In an embodiment, a large language model (LLM) may use the Persona structure to rephrase a base prompt 136 into the selected persona's style, ensuring high resonance, emotional relevance, sustained engagement, and the like. Without limitation, the prompting engine may store and reference multiple Persona structures per user, enabling adaptive prompting based on context, time of day, or evolving strategic needs. In an embodiment, this configuration may allow the apparatus 100 to deliver context-sensitive prompts that feel personalized, familiar, and aligned with each user's motivational profile. In some embodiments, a large language model may be used to rephrase prewritten prompts into the tone, style, or voice of a selected persona to enhance emotional resonance and engagement. In an embodiment, users may optionally schedule a particular time of day at which to receive their prompts. In another embodiment, the apparatus 100 may treat non-responsiveness as a contextual signal, adjusting cadence or escalatory interventions accordingly. Without limitation, other prompting contexts may include low engagement levels, missed deadlines, conflicting task priorities, team friction events, or organizational shifts in focus.

With continued reference to FIG. 1, the apparatus 100 may include an alignment engine feedback loop. The alignment engine feedback loop may also be referred to as the alignment engine and/or a “bottom-up” mechanism. In an embodiment, the alignment engine feedback loop may be designed to surface and elevate insights from team members, individual contributors, and functional staff to promote alignment across the organization. The insights may be derived from the entity input. Without limitation, the feedback loop may be part of the apparatus 100, which leverages natural language understanding, intelligent prompting, real-time analysis, and the like to identify and address misalignment at scale. Without limitation, the alignment engine may be configured to initiate prompts and collect input from users in response to internal changes, strategic pivots, workflow transitions, and the like, to ensure that the voices of frontline employees are represented in the strategic decision-making process. In an embodiment, the alignment engine may include a context-aware prompting engine, as described herein, that monitors changes such as new role assignments, leadership transitions, shifting priorities, and the like. Upon detecting such a change, the prompting engine may deliver a context-sensitive prompt directly to the affected users. Continuing, these prompts may request open-ended input related to responsibilities, clarity, personal satisfaction, resource constraints, perceived gaps in communication, and the like. For instance, without limitation, if a department is reorganized, individual team members may be asked to describe whether their day-to-day tasks have shifted, whether they feel they have the tools and authority to perform effectively, and how the reorganization is influencing team cohesion. In another non-limiting example, during a shift in quarterly goals, the prompting engine may ask users whether they understand the new priorities and how confident they are in their ability to contribute to them. Continuing, without limitation, the responses collected from individual users may be processed by an aggregation engine, which is a software component responsible for combining feedback from multiple sources and synthesizing it into a coherent, analyzable dataset. In an embodiment, the aggregation engine may use natural language processing (NLP) to detect patterns across responses. For example, sentiment analysis may be used to determine the overall tone of user feedback, such as whether responses reflect optimism, confusion, frustration, and the like. In another non-limiting example, the aggregation engine may implement clustering algorithms to identify themes, such as recurring references to “unclear expectations,” “lack of training,” or “uncertainty about product vision.” Without limitation, these techniques may allow the apparatus 100 to consolidate hundreds or thousands of free-text responses into a handful of key insights that represent the collective voice of the team. Without limitation, to make this aggregated data 156 actionable, the apparatus 100 may present it within a dashboard interface, which may serve as the primary visualization and interaction layer for executives, team leads, or human resources personnel. Without limitation, the dashboard interface may include sentiment trend lines over time, alert badges highlighting departments with alignment issues, word clouds displaying the most frequently mentioned terms, side-by-side comparisons of feedback across roles or business units, and the like. In an embodiment, the dashboard may allow users to drill down into specific themes, sort feedback by persona types, generate summary reports suitable for board meetings or cross-functional reviews, and the like. For example, without limitation, an executive viewing the dashboard may see that while the marketing department is aligned with current objectives, the engineering team shows repeated sentiment of “lack of clarity,” prompting immediate follow-up. Continuing, to determine which issues to present most prominently in the dashboard, the apparatus 100 may use a scoring function and/or prioritization engine that evaluates each aggregated insight along several dimensions. As used in this disclosure, a “prioritization engine” is a software component or that uses one or more scoring functions to evaluate, rank, and organize input data. In an embodiment, the input data may include entity input, aggregated user feedback, entity feedback, contextual signals, operational metrics, and the like. In an embodiment, the prioritization engine may be configured to identify the most relevant or urgent items for display or action. In an embodiment, the prioritization engine may receive input from an aggregation engine and apply a combination of rule-based logic, machine learning models, or reinforcement learning algorithms to determine how feedback should be surfaced within a dashboard or recommendation system. Without limitation, the prioritization engine may adapt its behavior over time based on feedback loops, historical effectiveness, or alignment with evolving business priorities. The prioritization engine may operate in real-time or batch-processing mode and may support multiple output formats such as ranked lists, heatmaps, or alert queues. In an embodiment, to determine which issues to present most prominently in the dashboard, the apparatus 100 may include a prioritization engine configured to apply a scoring function to each aggregated insight. The prioritization engine may be implemented as part of a machine learning pipeline that receives input from the aggregation engine and computes relevance scores for surfaced feedback themes.

With continued reference to FIG. 1, as used in this disclosure, a “scoring function” is a computational method that assigns a numerical or categorical value to an input based on one or more evaluative criteria. Without limitation, the input may include a user response, aggregated theme, insight, entity input, entity feedback, and the like. Without limitation, a scoring function may take into account dimensions such as response frequency, sentiment polarity, role hierarchy, temporal urgency, or strategic relevance. In an embodiment, the scoring function may be implemented using a weighted formula, where each input dimension contributes to the final score based on configurable or learned parameters. For example, a scoring function may assign higher values to insights that appear across multiple users within a short time period, contain negative sentiment, and are aligned with ongoing organizational objectives. The resulting score may be used to rank, filter, or elevate certain issues within a dashboard or alerting interface. Without limitation, the scoring function may evaluate each insight across multiple dimensions, including volume of similar responses, user sentiment, role-based weighting, and organizational context. In an embodiment, volume-based scoring may involve computing the frequency of similar comments across users or teams using natural language clustering techniques. For instance, if fifty employees reference “lack of clarity” or similar phrases within a short timeframe, the apparatus 100 may assign a higher frequency score to that insight. In another non-limiting example, the apparatus 100 may apply sentiment weighting using a natural language processing model that scores the emotional tone of user responses. For example, negative or urgent sentiment (“I feel completely lost,” “this isn't sustainable”) may increase the priority level, while neutral or positive sentiment (“we're adjusting well,” “this was a good change”) may reduce it. In an embodiment, the scoring function may also incorporate role-based weighting using a role hierarchy or organizational importance signal. For example, feedback from team leads, key contributors, or users aligned with high-impact initiatives, such as a product launch, may be assigned greater weight. This weighting may be derived from structured data fields within the entity input, including team designation, performance metrics, or organizational alignment data. Without limitation, strategic alignment factors may also be considered, wherein each insight is evaluated for its relevance to ongoing business goals or key performance indicators (KPIs). For example, if a company's quarterly objective includes improving onboarding workflows, and multiple employees raise concerns about training clarity, the apparatus 100 may cross-reference the issue with active OKRs and elevate its score accordingly. In an embodiment, the prioritization engine may apply temporal scoring models, where the recency and velocity of issue reporting affect its visibility. For example, a sudden spike in feedback regarding a new policy or system rollout may be interpreted as an emerging issue, prompting the system to raise it to the top of the dashboard interface. The prioritization engine may use these combined dimensions to compute a composite score for each aggregated insight. Without limitation, the scores may be ranked and fed into the dashboard interface to determine ordering, emphasis such as visual weight or alerts, or placement in executive summaries. In an embodiment, the scoring logic may be adaptive, learning over time which types of feedback historically required executive attention, and updating the weighting rules based on those outcomes. Without limitation, the scoring infrastructure may enable the apparatus 100 to filter noise from signal and ensure that the most important, high-impact issues are presented with prominence, facilitating timely and strategic responses from leadership. Without limitation, the scoring function may include the volume of similar responses, the urgency inferred from language cues, the strategic importance of the function reporting the issue, or correlation with business KPIs. For instance, if multiple users in a high-priority team report difficulty using a new software platform, and that same team is responsible for a critical customer-facing launch, the issue may be elevated to the top of the dashboard regardless of whether similar feedback is received from other departments. The feedback collected may be cycled back into the training dataset for the prompting engine and the alignment engine itself. This continuous feedback loop allows the apparatus 100 to evolve and refine how and when it prompts users, what kinds of questions result in high-fidelity answers, and how responses are interpreted or scored. For example, if the apparatus 100 learns that team members respond more constructively to prompts framed with positive reinforcement rather than neutral tones, the prompting engine may adjust its phrasing in future prompts to elicit more actionable feedback. Through these combined components, the prompting engine, the aggregation engine, and the dashboard interface, the alignment engine may act as an intelligent mediator between frontline employees and leadership. It may help detect gaps early, increase visibility into implementation challenges, foster an inclusive culture of transparency and realignment, and the like. In effect, this architecture may enable an organization to continuously calibrate itself in response to real human signals, not just top-down mandates.

Still referring to FIG. 1, the at least a processor 104 receives return data 140 associated with the prompt 136 from the user device 116. As used in this disclosure, a “return datum” is user-provided data received by the apparatus 100 in response to a prompt 136 generated by the prompting model 132. The return datum is associated with a previously issued prompt 136 and is intended to address one or more gaps, ambiguities, or information needs identified in connection with the original inquiry datum 120 and the plurality of reference data 112. The return datum may include, without limitation, textual responses, numerical inputs, structured forms, selected options, file uploads, or any other form of user input submitted through the user device 116. In an embodiment, the return datum supplements or completes the reference data 112 and may be used in the generation of an optimal output 148 by the apparatus 100. For example, without limitation, if a CEO submits an inquiry such as “Develop a Q3 hiring plan,” and the prompting model 132 issues a prompt 136 requesting “Please provide current department-level headcount data,” the user's response of “Marketing: 12, Sales: 18, Engineering: 25” constitutes a return datum. In a non-limiting example, if an executive requests “Prepare a report on customer chum trends,” and the prompt 136 generated by the apparatus 100 asks “Please upload customer retention metrics from the past four quarters,” a spreadsheet file submitted by the user in response qualifies as a return datum. In another non-limiting example, if a prompt 136 generated in response to an inquiry such as “Evaluate supply chain risks” asks “Please provide recent incident reports or delivery delays from suppliers,” a set of uploaded PDF summaries or a typed note stating “Supplier A missed shipments in April and May” may serve as the return datum.

Still referring to FIG. 1, the at least a processor 104 generates, using an aggregate model 144, an optimal output 148, wherein generating the optimal output 148 comprises aggregating the return data 140 and the plurality of reference data 112, identifying key data 152 from the aggregated data 156, and generating the optimal output 148 as a result of the identified key data 152. As used in this disclosure, an “aggregate model” is a computational model configured to combine, align, and semantically unify multiple sources of data, including but not limited to return data 140 and reference data 112, to form a coherent, integrated representation suitable for downstream processing. The aggregate model 144 may employ one or more techniques such as vector embedding, semantic alignment, dimensionality reduction, data normalization, clustering, or other machine learning or statistical techniques to enable the apparatus 100 to extract meaningful patterns and relationships across disparate data inputs. In an embodiment, the aggregate model 144 is used by the apparatus 100 to prepare aggregated data 156 for the identification of key data 152 and the generation of an optimal output 148. In an embodiment, the aggregate model 144 may include, without limitation, one or more machine learning (ML) or artificial intelligence (AI) models configured to semantically combine and interpret the return data 140 and the plurality of reference data 112. The aggregate model 144 may be implemented using various model architectures and approaches, depending on the complexity, format, and domain of the data involved. For example, without limitation, the aggregate model 144 may comprise natural language processing (NLP) models trained to parse, encode, and interpret unstructured text data. Such models may include transformer-based architectures capable of generating contextual vector embeddings for textual content, which may be used to align semantically similar data points within a unified vector space. In a non-limiting example, the aggregate model 144 may incorporate a large language model (LLM) that has been fine-tuned on domain-specific data to perform tasks such as semantic comparison, clustering, or pattern recognition across aggregated textual inputs. The LLM may be used to extract latent relationships between inquiry-specific information and supporting context within the return data 140 and reference data 112. In another non-limiting example, the aggregate model 144 may include one or more convolutional neural networks (CNNs) configured to process image-based or tabular representations of data, such as scanned documents or heat maps. CNNs may be used to extract features that are subsequently integrated with textual features in a multimodal embedding space. Without limitation, recurrent neural networks (RNNs) or long short-term memory (LSTM) networks may be used when the aggregated data 156 includes sequential dependencies, such as historical time series, procedural logs, or chained decision outcomes, where understanding the order and temporal relationships is critical for identifying key data 152. In an embodiment, the aggregate model 144 may further employ dimensionality reduction techniques, such as principal component analysis (PCA), t-distributed stochastic neighbor embedding (t-SNE), or Uniform Manifold Approximation and Projection (UMAP), to reduce the complexity of high-dimensional vector spaces while preserving meaningful relationships between data points. For example, without limitation, the aggregate model 144 may be trained using supervised learning approaches, where labeled training data includes examples of inquiry-related data and corresponding optimal outputs 148. Alternatively, the model may be trained using unsupervised or semi-supervised methods, including clustering or contrastive learning, to detect patterns or groupings within unstructured or loosely annotated data. In another embodiment, the aggregate model 144 may incorporate attention mechanisms to selectively prioritize features within the aggregated data 156 based on relevance to the inquiry datum 120. This may be particularly useful when the model must process large volumes of heterogeneous information. Without limitation, the aggregate model 144 may be trained using historical inquiry-prompt-response sequences, enabling it to learn common data associations, domain expectations, and optimal data configurations. Training data may include synthetic examples, real-world business data, or expert-curated corpora depending on the application domain.

With continued reference to FIG. 1, as used in this disclosure, an “optimal output” is a generated result produced by the apparatus 100 in response to an inquiry datum 120. In an embodiment, the optimal output 148 may be computed based on the integration of reference data 112 and return data 140, and reflects the most relevant, complete, and contextually appropriate response to the user's inquiry. The optimal output 148 may include, without limitation, a recommendation, summary, forecast, report, decision pathway, or other synthesized deliverable intended to support or inform the user's decision-making. In an embodiment, the optimal output 148 is derived from key data 152 identified within the aggregated data 156 and represents the highest utility response that can be generated given the available inputs. As used in this disclosure, “key data” is a subset of the aggregated data 156 determined by the apparatus 100 to be most relevant, influential, or informative with respect to the inquiry datum 120. The identification of key data 152 may be based on one or more methods, including but not limited to scoring functions, feature importance rankings, semantic similarity, clustering outputs, domain-specific heuristics, or machine learning-based signal detection. In an embodiment, the key data 152 serves as the basis for generating the optimal output 148 and may represent core facts, quantitative indicators, or critical context extracted from the broader data set. In an embodiment, the processor 104 may use the aggregate model 144 to first combine the return data 140 such as user-provided responses to one or more prompts, with the existing reference data 112 previously received from the user device 116. This aggregation step may involve converting both data sources into vector representations using, for example without limitation, natural language embedding models or multimodal encoders. The resulting vectors may be aligned into a unified semantic space to facilitate comparison, fusion, and analysis across different data formats. For example, without limitation, if a CEO submits an inquiry such as “What is our projected capacity to scale production in Q1?”, and the reference data 112 includes factory blueprints, staffing reports, and historical throughput logs, while the return data 140 includes recently submitted procurement lead times and maintenance schedules, the aggregate model 144 may unify these disparate inputs into a coherent format for downstream processing. In another non-limiting example, the aggregate model 144 may use attention-based mechanisms or similarity scoring to identify key data 152, which may represent the most relevant or influential data points for answering the inquiry. For instance, within the aggregated data 156, the aggregate model 144 may detect that equipment availability and average repair turnaround time are strongly predictive of production capacity, and therefore select those data elements as key data 152. In an embodiment, identifying the key data 152 may include applying dimensionality reduction techniques, such as t-SNE or UMAP, to map high-dimensional data into clusters, followed by selection of representative data points within each cluster using a scoring function. Without limitation, the scoring function may weigh attributes such as semantic similarity to the inquiry, data freshness, or relevance to prior output structures. For example, without limitation, if the aggregated data 156 contains dozens of operational metrics, the model may prioritize those most statistically correlated with throughput bottlenecks, such as average downtime or workforce availability, and treat them as key data 152. The optimal output 148 may then be generated based on the key data 152, which serves as the distilled, decision-relevant subset of the user's full dataset. The optimal output 148 may be produced in a variety of formats, including but not limited to executive summaries, action recommendations, resource allocation plans, or visual dashboards. Without limitation, the optimal output 148 may be generated as an executive summary, which may include a natural language overview of findings, risks, and recommendations derived from the aggregated data 156. In some embodiments, the optimal output 148 may take the form of one or more action recommendations, which may include suggested next steps, operational interventions, or decision pathways informed by the identified key data 152. For example, without limitation, the action recommendations may include resource reassignments, vendor changes, or prioritization of initiatives. In other embodiments, the optimal output 148 may be rendered as a resource allocation plan, such as a proposed distribution of capital, personnel, or infrastructure across business units or timeframes. Additionally and/or alternatively, the optimal output 148 may be displayed as a visual dashboard, which may include charts, heatmaps, timelines, or other graphical representations of performance indicators, forecasts, or decision metrics. The format of the optimal output 148 may be selected automatically by the apparatus 100 based on the inquiry category or may be configurable by the user to suit a particular business or strategic context. In a non-limiting example, for an inquiry such as “Recommend actions to reduce Q2 overhead,” the model may identify, from aggregated HR and cost center data, that overtime labor costs and underutilized office leases are primary drivers. Based on these key data 152 points, the optimal output 148 may include a proposed reduction in overtime scheduling and a recommendation to consolidate office space. In another embodiment, the aggregate model 144 may be enhanced through iterative refinement, wherein newly submitted return data 140 in response to follow-up prompts is continually re-aggregated and re-analyzed to improve the accuracy or completeness of the optimal output 148. This may allow the processor 104 to dynamically generate updated outputs as more information becomes available. Without limitation, this process may enable the system to simulate how an expert analyst might synthesize fragmented business inputs into actionable conclusions, and it may be applied across a variety of executive-level use cases, including strategic planning, financial forecasting, workforce optimization, and compliance assessments.

With continued reference to FIG. 1, the at least a processor 104 may be further configured to aggregate, using the aggregate model 144, the return data 140 and the plurality of reference data 112 by converting the return data 140 and the plurality of reference data 112 into corresponding vector embeddings, and combining the vector embeddings into a unified semantic space. As used in this disclosure, “corresponding vector embeddings” are numerical representations of data elements produced by one or more embedding models. The data elements may include the return data 140 and the plurality of reference data 112. Without limitation, each vector embedding may correspond to a specific unit of input data and captures semantic, structural, or contextual characteristics of that data in a high-dimensional vector space. In an embodiment, the embedding model may be configured to transform heterogeneous data types, including but not limited to natural language text, numerical values, categorical labels, or tabular entries, into vector embeddings that are mathematically comparable. The generation of corresponding vector embeddings may enable the apparatus 100 to evaluate similarity, perform clustering, or apply machine learning techniques to aggregated data 156 in a consistent and computationally efficient manner. As used in this disclosure, a “unified semantic space” is a high-dimensional embedding space in which the corresponding vector embeddings of the return data 140 and the plurality of reference data 112 are co-located and aligned in such a way that semantically or contextually similar data points are positioned in close proximity. The unified semantic space enables the apparatus 100 to perform joint analysis across different data types or sources by treating the embeddings as points within a shared mathematical framework. In an embodiment, the unified semantic space may be constructed using one or more techniques, including but not limited to feature normalization, embedding alignment, dimensionality reduction, or domain-specific calibration. The unified semantic space allows for downstream operations such as semantic similarity scoring, clustering, key data 152 identification, or optimal output 148 generation. In an embodiment, this may involve applying one or more embedding models, such as transformer-based natural language encoders, numerical feature extractors, or domain-specific encoders, that are trained to capture semantic, contextual, or structural relationships within the data. As used in this disclosure, a “transformer-based natural language encoder” is a machine learning model architecture configured to process and encode unstructured text into numerical vector representations that capture the semantic meaning and contextual relationships of the text. In an embodiment, transformer-based natural language encoders may utilize self-attention mechanisms to model dependencies between words or phrases, enabling the encoder to capture both local and global context in a given input sequence. Without limitation, examples of transformer-based encoders may include models such as BERT (Bidirectional Encoder Representations from Transformers), RoBERTa, or DistilBERT. Such encoders may be used by the apparatus 100 to convert textual inquiry data, reference data 112, or return data 140 into corresponding vector embeddings for inclusion in a unified semantic space. As used in this disclosure, a “numerical feature extractor” is a computational model configured to transform raw numerical or structured data into feature vectors that are suitable for downstream machine learning or aggregation tasks. In an embodiment, numerical feature extractors may normalize, scale, or encode numerical data to highlight patterns, trends, or statistical relationships. Without limitation, such extractors may include statistical summarizers, principal component analyzers, or neural network-based encoders specifically trained to learn latent representations of numerical datasets. For example, without limitation, historical sales metrics, revenue growth rates, or cost data may be processed by numerical feature extractors to create embeddings that capture temporal or categorical patterns for inclusion in the aggregate model 144. As used in this disclosure, a “domain-specific encoder” is an encoder model tailored or fine-tuned to a particular field, industry, or data domain. The industry or data domain may include, without limitation, legal, financial, healthcare, or manufacturing. In an embodiment, a domain-specific encoder may incorporate domain knowledge, specialized vocabularies, or feature engineering techniques designed to improve performance on domain-relevant tasks. Without limitation, a domain-specific encoder may use a modified transformer-based architecture pre-trained on industry-specific corpora (e.g., patent filings or regulatory documents) or may include rule-based feature mappings that capture unique structures, terms, or relationships inherent to the domain. For example, without limitation, in a patent prosecution context, a domain-specific encoder may be configured to detect and vectorize claim language, prior art references, or examiner communications. Without limitation, each data element, whether textual, numerical, categorical, or multimodal, may be encoded into a fixed-length or variable-length vector, wherein each vector numerically represents the position and meaning of the underlying content within a high-dimensional space. For example, without limitation, a return datum such as a user-provided statement “Our sales in Q2 underperformed expectations” may be converted into a dense vector using a pretrained language model, while a reference datum comprising tabular sales figures or historical benchmarks may be vectorized using statistical or learned encoders designed to handle structured inputs. In this way, both qualitative and quantitative inputs may be transformed into vector embeddings that are mathematically comparable. Once the return data 140 and reference data 112 have been encoded into their corresponding vector embeddings, the at least a processor 104 may be further configured to combine these embeddings into a unified semantic space. In an embodiment, the unified semantic space may be constructed by aligning the embeddings using shared embedding dimensions or through projection techniques that map different data modalities into a common analytical frame. Without limitation, the unified semantic space may be calibrated to ensure that semantically or contextually similar data points from different sources are positioned in close proximity, thereby allowing the apparatus 100 to perform operations such as clustering, anomaly detection, key data 152 extraction, or similarity scoring across the aggregated dataset. For example, in a non-limiting example, if the return data 140 includes updated financial risk commentary and the reference data 112 includes historical performance metrics, the processor 104 may use the unified semantic space to determine areas of convergence or discrepancy, identifying clusters of related inputs that support the generation of a refined, context-aware optimal output 148. In another embodiment, the processor 104 may use the unified semantic space to apply downstream models, such as attention-based aggregators or dimensionality reducers, to extract key data 152 elements most relevant to the user's inquiry. The use of vector embeddings and a unified semantic space allows the apparatus 100 to integrate and analyze heterogeneous data sources with consistency, flexibility, and semantic sensitivity.

With continued reference to FIG. 1, the at least a processor 104 may be further configured to identify, using the aggregate model 144, the key data 152 from the aggregated data 156 by performing dimensionality reduction on the unified semantic space, clustering reduced embeddings into a plurality of clusters, and selecting a representative data point from each cluster of the plurality of clusters based on a scoring function. As used in this disclosure, a “cluster” is a grouping of vector embeddings within a unified semantic space, wherein the embeddings in a given group exhibit higher similarity to each other than to embeddings in other groups. In an embodiment, a cluster may represent a subset of aggregated data 156 points, such as reference data 112 and return data 140, that share common semantic, statistical, or contextual characteristics. Without limitation, clustering may be performed using algorithms such as k-means, hierarchical clustering, DBSCAN, or other unsupervised machine learning techniques, following the application of dimensionality reduction to the vector embeddings. Each cluster may correspond to a distinct topical area, data pattern, or thematic segment within the aggregated data 156. As used in this disclosure, a “representative data point” is a selected data element from within a cluster that is determined, based on a scoring function, to most accurately or effectively reflect the semantic content or relevance of the cluster as a whole. In an embodiment, the representative data point may be identified by evaluating all embeddings within a cluster against a scoring function, which may include, without limitation, measures of centrality, similarity to the inquiry datum 120, domain relevance, or historical effectiveness in prior outputs. The representative data point may serve as a proxy for its cluster during key data 152 identification and may be used by the apparatus 100 to generate the optimal output 148. In a non-limiting example, a CEO may submit an inquiry such as “What are the most pressing operational risks we face next quarter.” The apparatus 100 may receive a plurality of reference data 112 from the user device 116, including prior risk assessments, equipment maintenance records, staff turnover logs, and budget variance reports. The user may then provide return data 140 in response to gap inquiries, such as updated vendor reliability scores or incident reports from regional facilities. The at least a processor 104 may aggregate the reference data 112 and return data 140 by converting each data element into a corresponding vector embedding. Each embedding may represent a numerical encoding of the content or meaning of the data, generated using natural language encoders or numerical feature extractors. The embeddings may then be positioned within a unified semantic space, where semantically similar data points are located closer together. To reduce the complexity of the semantic space, the at least a processor 104 may apply a dimensionality reduction technique, such as principal component analysis or uniform manifold approximation and projection. This transformation may preserve the relative positions of the vector embeddings while projecting them into a lower-dimensional space that is more computationally manageable. Within the reduced space, the at least a processor 104 may perform clustering to group the embeddings into a plurality of clusters. For example, without limitation, one cluster may include data related to equipment failure risks, another cluster may correspond to staffing and attrition concerns, and another may contain financial irregularities. From each cluster, the at least a processor 104 may apply a scoring function to identify a representative data point. The scoring function may rank each data point within the cluster based on its semantic similarity to the inquiry datum 120, its relevance score derived from historical inquiry-response patterns, or its centrality within the cluster. In this example, the representative data point for the equipment cluster may be “frequent downtime of packaging line three,” while the representative point for the financial cluster may be “unresolved vendor payment discrepancies in Q3.” The identified representative data points may then be surfaced as key data 152, and used by the apparatus 100 to generate the optimal output 148, such as a risk prioritization summary or a recommended mitigation plan.

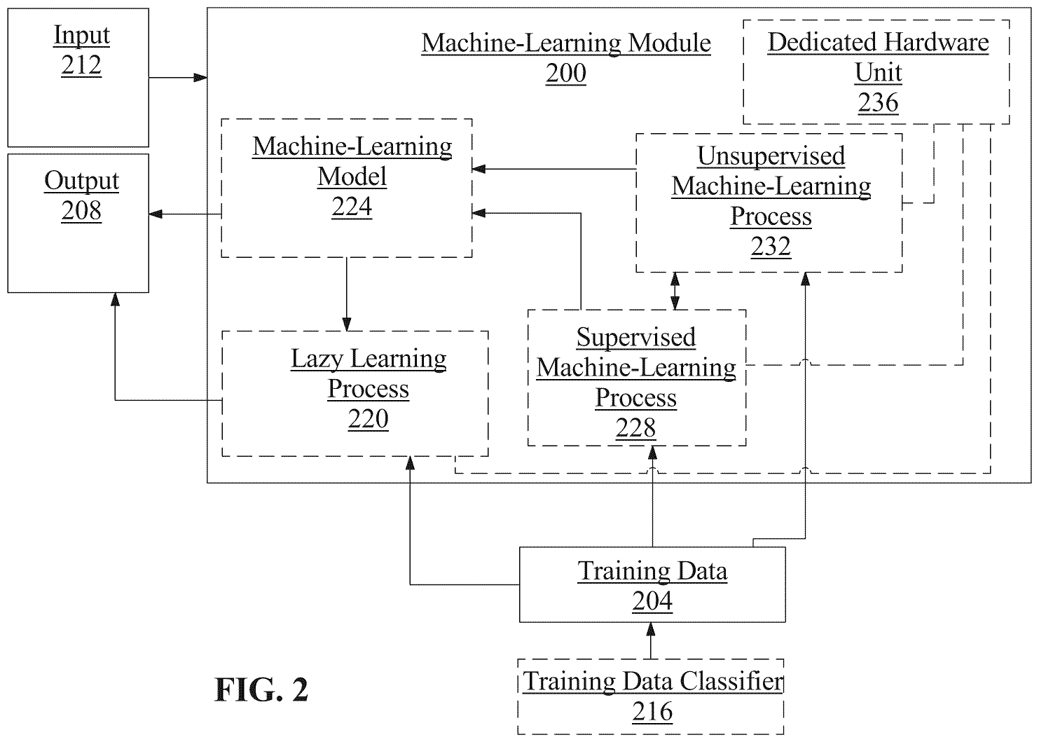

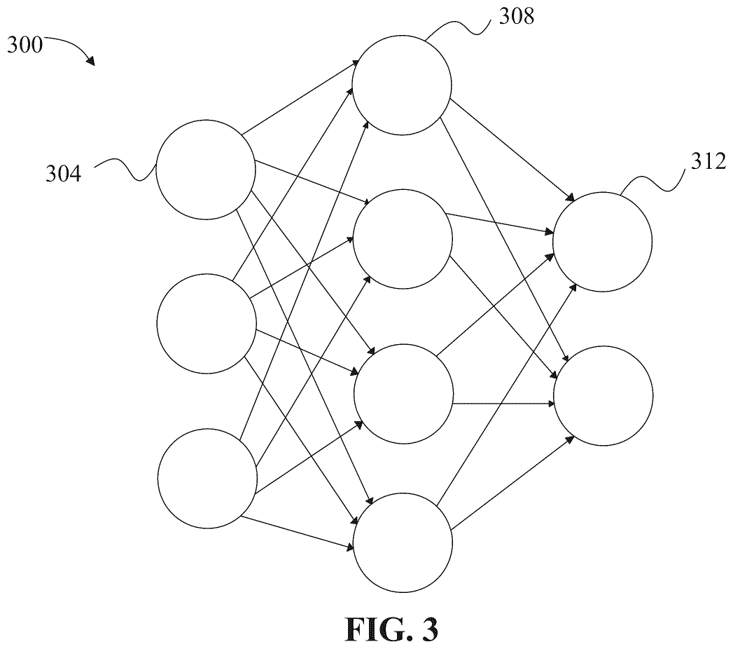

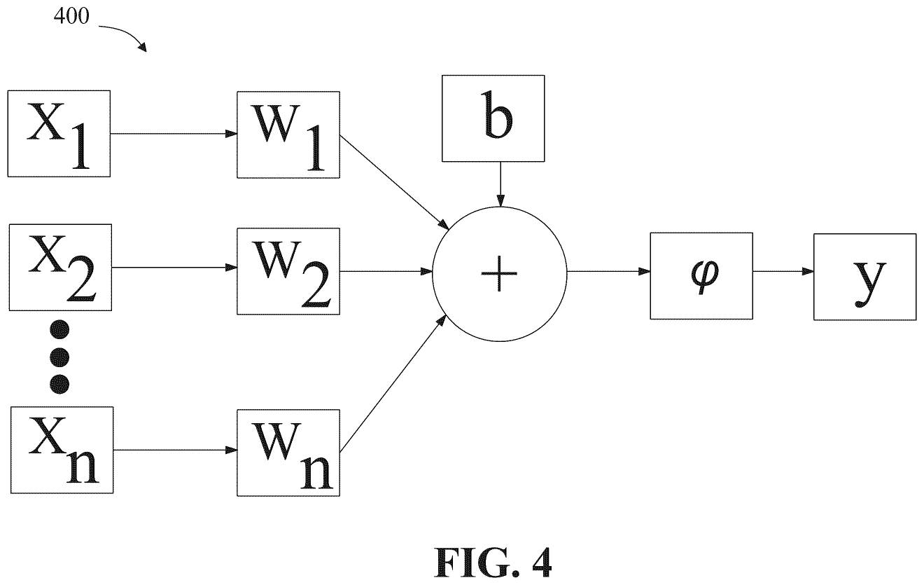

With continued reference to FIG. 1, the first optimizer may include a first large language model, wherein the first at least a large language model may include a large language model (LLM). As used in this disclosure, a “large language model” is a data structure representing and/or instantiating a mathematical and/or algorithmic representation of a relationship between inputs and outputs, as generated using any machine-learning process. Without limitation, the at least a large language model is discussed in more detail in FIG. 2. As used in this disclosure, a “neural network” is a computational model consisting of interconnected nodes organized in layers as further discussed in FIG. 3 and FIG. 4.

With continued reference to FIG. 1, without limitation, apparatus 100 may further include a second optimizer comprising a second at least a large language model, wherein the second large language model may be configured to process sequestered data within a private large language model. As used in this disclosure, “sequestered data” is data that is isolated and protected within a secure environment to prevent unauthorized access and ensure confidentiality. Continuing, the sequestered data may include sensitive or proprietary information, and may require special handling and security measures to maintain its integrity and privacy. Without limitation, sequestered data may be stored separately from other datasets. In a non-limiting example, sequestered data may only be accessed by authorized personnel or systems under specific conditions. For instance, without limitation, sequestered data may include an employee performance review, health records, and the like. As used in this disclosure, a “private LLM” is a large language model that is designed to operate within a restricted environment. In a non-limiting example, the private LLM may allow organizations to input and process confidential or sensitive information securely. Continuing, unlike public LLMs, which are trained on broad datasets available to the general public, private LLMs are tailored to use specific datasets that may include proprietary company data, internal documents, or any sensitive information that the organization wishes to protect. Without limitation, the data used and generated by the private LLM may remain confidential and may not get exposed to external entities. Without limitation, the private LLM may be suitable for applications like personalized business insights, strategic planning, and decision-making processes involving sensitive data. In another non-limiting example. A company may implement a private LLM to handle sequestered data and ensure that the sensitive or proprietary information remains isolated within a secure environment. Without limitation, the private LLM may be trained exclusively on internal company data, such as confidential financial reports, intellectual property documents, and strategic planning materials, and the like. In a non-limiting example, the private LLM may be configured to process and generate insights from the sequestered data while maintaining the confidentiality of the information. For example, the private LLM may provide internal recommendations, summaries, and or analysis to authorized users. For instance, without limitation, this may include implementing encryption protocols, role-based access controls, and audit trails to maintain the integrity and privacy of the sequestered data within the private LLM.

Still referring to FIG. 1, the apparatus 100 may include a large language model (LLM). A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include books, articles, and case studies on business strategy, management principles, reports from market research firms that provide insights into different industries, emerging trends, the impact of AI on various sectors, information on common business processes, workflows, operational strategies across different industries, datasets containing customer feedback, employee surveys, organizational change management studies, and the like. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive an article and apply a probability distribution to the words already typed in a sentence to work out the most likely word to come next in augmented articles. For example, if some words that have already been typed are “how should I integrate AI”, then it may be highly likely that the words “into my business” will come next. An LLM may output such predictions by ranking words by likelihood or a prompt parameter. For the example given above, an LLM may score “you” as the most likely, “your” as the next most likely, “his” or “her” next, and the like. An LLM may include an encoder component and a decoder component.

Still referring to FIG. 1, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1, multi-headed attention in encoder may apply a specific attention mechanism called self-attention. Self-attention allows models such as an LLM or components thereof to associate each word in the input, to other words. As a non-limiting example, an LLM may learn to associate the word “you”, with “how” and “are”. It's also possible that an LLM learns that words structured in this pattern are typically a question and to respond appropriately. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 1, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 1, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device 116. User device 116 may be any computing device that is used by a user. As non-limiting examples, user device 116 may include desktops, laptops, smartphones, tablets, and the like. In some embodiments, input may include any set of data associated with business data, management data, and the like.

With continued reference to FIG. 1, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With continued reference to FIG. 1, the first optimizer and the second optimizer may engage in a simulated environment where each optimizer may represent an autonomous agent with predefined objectives. As used in this disclosure, a “simulated environment” is a virtual or artificial setting created to mimic real-world conditions and scenarios for the purpose of testing, training, or optimizing algorithms and models. This environment may allow for controlled experimentation and evaluation of different strategies and decisions without the risks and costs associated with real-world implementation. As used in this disclosure, an “autonomous agent” is a self-operating entity. In a non-limiting example, the autonomous agent may be implemented as a software program or algorithm, that can make decisions and perform actions independently based on predefined rules, objectives, and environmental inputs. These agents may be capable of learning from their experiences and adapting their behavior to achieve specific goals within the simulated environment. As used in this disclosure, “predefined objectives” are specific goals and or targets established prior to the execution of a process or operation. These objectives may guide the actions and decisions of autonomous agents within the simulated environment, ensuring that their behavior aligns with the desired outcomes and performance criteria set by the entity or system designers.

With continued reference to FIG. 1, each optimizer generates a first iterative output, wherein the first iterative output is used to refine a second iterative output generated by each optimizer. As used in this disclosure, a “first iterative output” is the initial result generated by an optimizer during the first iteration of a process. The first iterative output may serve as a preliminary solution or recommendation based on the initial set of inputs and parameters. The first iterative output is subject to further refinement and adjustment in subsequent iterations. As used in this disclosure, a “second iterative output” is the refined result generated by an optimizer during a subsequent iteration of a process, following the first iterative output. In a non-limiting example, the second iterative output may incorporate adjustments and improvements based on optimizer feedback, additional data, or further analysis, aiming to provide a more accurate and optimized solution or recommendation.

Still referring to FIG. 1, processor 104 may receive entity feedback comprising at least a correction datum. As used in this disclosure, “entity feedback” refers to the information provided by the entity after reviewing the optimal output 148 generated by the first optimizer. This feedback can include evaluations, comments, corrections, or any other form of input that indicates how well the optimal output 148 meets the entity's needs or where adjustments are necessary. For instance, without limitation, if the optimal output 148 includes a project timeline that the entity finds unrealistic, the entity feedback may include a correction datum suggesting a more feasible timeline based on recent project performance data. Additionally and or alternatively, if the optimal output 148 proposes a marketing strategy that the entity believes is not aligned with its brand image, the entity feedback could include comments and suggestions for alternative strategies that better fit the brand's identity. As used in this disclosure, a “correction datum” is to a specific piece of information within the entity feedback that identifies an error, discrepancy, or area for improvement in the optimal output 148. The correction datum may be used to retrain the first optimizer to enhance its accuracy and performance in generating future optimal output 148.

Still referring to FIG. 1, processor 104 may retrain, using the entity feedback, the first optimizer. In a non-limiting example, if the optimal output 148 generated by the first optimizer suggested a resource allocation strategy that did not align with the entity's operational constraints, the entity feedback may include specific corrections indicating the misalignment. The correction datum may specify that certain resources are over-allocated or under-allocated. Processor 104 may then use this correction datum to adjust the training data and retrain the first optimizer to better account for these constraints in future outputs. In another non-limiting example, the optimal output 148 may include a financial forecast that the entity finds overly optimistic based on recent market trends. Continuing, the entity feedback may include a correction datum that provides updated market data or revised financial assumptions. Continuing, processor 104 may incorporate this new information into the entity training data and retrain the first optimizer to generate more accurate financial forecasts in subsequent iterations. Without limitation, the optimal output 148 may recommend a strategic decision that the entity deems too risky. Continuing, the entity feedback may include a correction datum highlighting the risk factors that were not adequately considered. Continuing, processor 104 may use entity feedback to update the entity training data, ensuring that the first optimizer takes these risk factors into account when generating future optimal output 148.

Still referring to FIG. 1, processor 104 may display, using a downstream device, the optimal output 148 through a graphical user interface of the downstream device. As used in this disclosure, a “downstream device” is an electronic device that presents information to the entity. In some cases, downstream device may be configured to project or show visual content generated by computers, video devices, or other electronic mechanisms. In some cases, downstream device may include a liquid crystal display (LCD), a cathode ray tube (CRT), a plasma display, a light emitting diode (LED) display, and any combinations thereof. In a non-limiting example, one or more downstream device may vary in size, resolution, technology, and functionality. Downstream device may be able to show any data elements and/or visual element as listed above in various formats such as, textural, graphical, video among others, in either monochrome or color. Downstream device may include, but is not limited to, a smartphone, tablet, laptop, monitor, tablet, and the like. Downstream device may include a separate device that includes a transparent screen configured to display computer generated images and/or information. In some cases, downstream device may be configured to present a graphical user interface (GUI) to a user, wherein a user may interact with a GUI. In some cases, a user may view a GUI through downstream device. Additionally, or alternatively, processor 104 be connected to downstream device. In one or more embodiments, transmitting optimal output 148 may include displaying optimal output 148 at downstream device using a visual interface.

As used in this disclosure, a “graphical user interface” is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, the graphical user interface is configured to display at least a visual element associated with the optimal output 148 and the score. As used in this disclosure, a “visual element” is a graphical component or representation that is displayed on a graphical user interface (GUI) to convey information to the user. This can include charts, graphs, icons, images, text, and other graphical indicators that help users understand and interact with the data or outputs generated by the system. Visual element may be designed to enhance the user experience by making complex data more accessible and easier to interpret. For example, without limitation, in the context of conducting performance reviews, the graphical user interface may display a visual element such as a bar chart that shows an employee's performance metrics over time. This chart could include different colored bars representing various performance indicators like productivity, quality of work, and teamwork. In another non-limiting example, the graphical user interface may display a visual element such as a line graph that tracks key performance indicators (KPIs) against strategic goals over a specified period. Continuing, this graph may include trend lines for revenue, market share, and customer satisfaction, allowing business leaders to easily identify trends and make data-driven decisions. In another non-limiting example, the graphical user interface may display a visual element such as a dashboard that aggregates various data points into a single view. Continuing, this dashboard may include pie charts showing the distribution of budget allocations, heat maps indicating areas of operational risk, and icons representing key action items.

Still referring to FIG. 1, the at least a processor 104 displays, using a user interface 160, the optimal output 148. As used in this disclosure, a “user interface” is a component or system through which a user interacts with an apparatus 100 or computing device, allowing for the presentation of outputs and the reception of inputs. A user interface 160 may include, without limitation, graphical user interfaces (GUIs), command-line interfaces, voice-based interfaces, or mixed-reality environments. In some implementations, a user interface 160 may be displayed on a display device such as a monitor, touchscreen, or head-mounted display, and may facilitate interaction by presenting the optimal output 148 and receiving user commands, feedback, or additional data inputs. In an embodiment, the at least a processor 104 may configured to present the optimal output 148 to the user by utilizing a user interface 160. Without limitation, the optimal output 148 generated based on the aggregation and analysis of reference data 112, inquiry data, and return data 140, may be visually or otherwise perceptibly rendered through the user interface 160. The user interface 160 may include any medium that supports user interaction or content display, such as a graphical display on a touchscreen device, a web interface, a command-line terminal, or an augmented reality overlay.

With continued reference to FIG. 1, the at least a processor 104 may be further configured to refine the optimal output 148 based on user feedback received after an initial optimal output, the user feedback comprising a correction datum. As used in this disclosure, “user feedback” is data received from the user device 116 after the presentation of an optimal output 148. The user feedback may include one or more indications of accuracy, relevance, completeness, or preference related to the presented optimal output. User feedback may include, without limitation, textual comments, selected options, rating values, suggested revisions, or direct modifications to the output content. As used in this disclosure, “initial optimal output” is the first generated version of an optimal output 148 produced by the apparatus 100 in response to a given inquiry datum 120 and based on the available return data 140 and reference data 112 at the time of generation. The initial optimal output may be displayed to the user using a user interface 160 and may be subject to refinement based on subsequent user feedback. The correction datum may be provided in textual form or through structured user inputs and is used by the apparatus 100 to improve the quality or accuracy of the optimal output 148 in subsequent iterations. In an embodiment, once the initial optimal output is generated and presented to the user, the apparatus 100 may receive follow-up input that identifies inaccuracies, suggests improvements, or provides alternative content. For example, without limitation, if the initial optimal output recommends reallocating staff from Department A to Department B, the user may submit a correction datum such as “Department A is already understaffed, consider pulling resources from Department C instead.” The at least a processor 104 may incorporate the correction datum into the existing data structure and update the optimal output 148 accordingly, using the aggregate model 144 and prompting model 132 as needed to ensure that the revised result reflects the updated context. This refinement process may allow the apparatus 100 to continuously adapt its outputs to align with user intent, real-time conditions, or evolving organizational requirements.

With continued reference to FIG. 1, the at least a processor 104 may be further configured to refine, using a retrieval-augmented generation system, the optimal output 148 by retrieving, using the at least a processor 104, supplemental data from at least one external source based on the inquiry datum 120 and the plurality of reference data 112, and incorporating, using the at least a processor 104, the supplemental data into a contextual input received by the prompting model 132, and refining, using the at least a processor 104, the optimal output 148 based on the contextual input. As used in this disclosure, a “retrieval-augmented generation system” is a system architecture that combines information retrieval techniques with text generation capabilities, wherein retrieved data is dynamically incorporated into a generated response. In an embodiment, the retrieval-augmented generation system may include a retriever component configured to identify relevant supplemental data from one or more data sources, and a generator component, such as a prompting model 132, that uses the retrieved data to produce context-aware outputs. This approach may enable the system to generate refined outputs grounded in both internal and external information. As used in this disclosure, “supplemental data” is additional data retrieved by the apparatus 100 from one or more sources other than the original reference data 112 or return data 140, wherein the supplemental data is used to enhance, clarify, or expand the context available to the prompting model 132. Supplemental data may include, without limitation, technical documents, third-party reports, public databases, regulatory guidelines, or proprietary knowledge bases that are relevant to the inquiry datum 120. As used in this disclosure, an “external source” is any data repository, content provider, or computational service that exists outside of the user device 116 or the apparatus 100 and that is accessible to the apparatus 100 for the purpose of data retrieval. In an embodiment, an external source may include cloud-based storage systems, third-party APIs, public websites, enterprise document repositories, or distributed knowledge graphs. As used in this disclosure, a “contextual input” is a composite input provided to the prompting model 132, comprising at least the inquiry datum 120, the plurality of reference data 112, and the supplemental data retrieved from one or more external sources. The contextual input may be used by the prompting model 132 to generate or refine a response that accounts for both the original user context and the newly retrieved data. In an embodiment, upon receiving an inquiry datum 120 and aggregating the plurality of reference data 112, the apparatus 100 may determine that additional context is needed to produce a more complete or accurate response. The processor 104 may then initiate a retrieval operation to obtain supplemental data from at least one external source, such as an enterprise content management system, a publicly available regulatory database, or a third-party analytics platform. Based on the subject matter of the inquiry, such supplemental data may include, for example without limitation, recent industry benchmarks, legal compliance updates, or current market intelligence. Once retrieved, the supplemental data may be combined with the original reference data 112 and the inquiry datum 120 to form a contextual input, which is then submitted to the prompting model 132. The prompting model 132 may analyze the contextual input and generate a refined version of the optimal output 148 that reflects the most relevant, complete, and up-to-date information available. This process enables the apparatus 100 to dynamically expand its knowledge base and adapt the optimal output 148 to reflect evolving external conditions or domain-specific developments.

With continued reference to FIG. 1, the at least a processor 104 may be further configured to generate a score associated with the optimal output 148, wherein generating the score comprises ranking, using the at least a processor 104, a plurality of optimal outputs, assigning, using the at least a processor 104, scores to each of the plurality of optimal outputs based on a similarity metric, and displaying, using the user interface 160, the score. As used in this disclosure, a “score” is a numerical or symbolic value generated by the apparatus 100 that indicates the relative quality, relevance, or suitability of an optimal output 148 with respect to a given inquiry datum 120. The score may be used to rank or prioritize one or more optimal outputs and may be presented to the user through the user interface 160. In an embodiment, the score may be computed based on one or more evaluation criteria, including but not limited to semantic alignment, completeness, clarity, consistency with historical outputs, or user preferences. As used in this disclosure, a “similarity metric” is a mathematical function or computational method used by the apparatus 100 to measure the degree of similarity between two or more data representations, such as between an inquiry datum 120 and an optimal output 148 or between multiple optimal outputs. In an embodiment, the similarity metric may be used to quantify how closely an optimal output 148 aligns with the expected or target characteristics of a response. Without limitation, similarity metrics may include cosine similarity, Euclidean distance, Jaccard similarity, or learned relevance functions trained on historical data. In an embodiment, the apparatus 100 may compute the score by first generating or retrieving a plurality of candidate optimal outputs that are each responsive to the same inquiry datum 120. The apparatus 100 may then apply a similarity metric to evaluate the degree to which each candidate output aligns with the semantic content, context, or intent of the inquiry datum 120. For example, without limitation, the apparatus 100 may use cosine similarity to compare vector embeddings of each optimal output 148 to those of the inquiry, or it may use a learned scoring model trained on historical data to predict which outputs are most likely to be useful to the user. Based on the similarity metric, the apparatus 100 may assign a numerical score to each of the plurality of optimal outputs and rank them in order of relevance or quality. The highest-scoring output may be designated as the preferred response, while the scores of the remaining outputs may be displayed through the user interface 160 to provide transparency or allow user selection. This scoring functionality may enable the apparatus 100 to support multi-output generation workflows, confidence estimation, or user-in-the-loop refinement processes.

With continued reference to FIG. 1, the at least a processor 104 may be further configured to display, using the user interface 160, at least a visual element associated with the optimal output 148 and the score, wherein the at least a visual element comprises metadata, wherein the metadata comprising a source identifier. As used in this disclosure, a “visual element” is a graphical, textual, or interactive component generated by the apparatus 100 and displayed using the user interface 160, wherein the visual element is configured to convey, represent, or enhance the presentation of an optimal output 148 and its associated score. In an embodiment, a visual element may include, without limitation, charts, tables, text blocks, icons, gauges, labels, or interactive controls such as dropdown menus or expandable sections. A visual element may be static or dynamically generated based on the structure and content of the optimal output 148. As used in this disclosure, “metadata” is auxiliary information associated with a data item, such as an optimal output 148 or a visual element, that provides descriptive, structural, or contextual details used to support interpretation, traceability, or interaction. In an embodiment, metadata may include, without limitation, timestamps, data sources, processing history, version information, or scoring annotations. As used in this disclosure, a “source identifier” is a portion of metadata that specifies the origin of a particular data item, including but not limited to the document, dataset, user input, or external system from which the data was derived. A source identifier may take the form of a file name, document title, hyperlink, database reference, or unique alphanumeric tag, and may be used by the apparatus 100 to trace or verify the provenance of data contributing to the optimal output 148. In an embodiment, the visual element may be configured to represent the optimal output 148 in a format that is accessible and interpretable by the user. For example, without limitation, the visual element may take the form of a summarized text block displaying the recommended course of action, alongside a numerical score indicating the confidence level assigned by the apparatus 100. The visual element may further include embedded metadata, which may provide context about how the optimal output 148 was generated, when it was generated, and which data sources were used. Among the metadata, the visual element may display a source identifier, which may inform the user of the specific origin of a key data 152 point used in the generation of the optimal output 148. For instance, the source identifier may appear as a label such as “Based on Q2 Supplier Report” or “Data pulled from Regulatory Update API,” enabling transparency and trust in the output of the apparatus 100. This display capability may assist users in validating results, exploring supporting information, and making informed decisions.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example inputs like the plurality of reference data and outputs like the optimal output.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to categories of the business, such as the decision type, the industry field, and the like.

Still referring to FIG. 2, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)+P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 2, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 2, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2} ,}$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or using user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 2, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 2, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 2, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{n e w} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{n e w} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{m e d i a n}}{IQR} .$$

Persons skilled in the art, upon reviewing the entirety of this disclosure, will be aware of various alternative or additional approaches that may be used for feature scaling.

Further referring to FIG. 2, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include the inquiry datum and the plurality of reference data as described above as inputs, the optimal output and the score as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 4, an exemplary embodiment of a node 400 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max(0, x), a “leaky” and/or “parametric” rectified linear unit function such as f(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of a (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2}/π(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

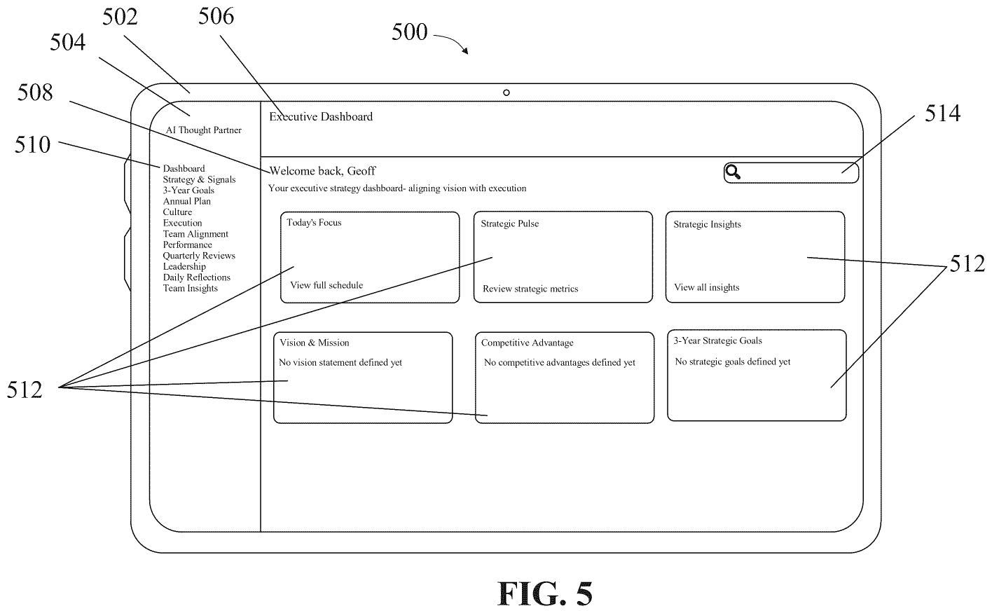

Referring now to FIG. 5, an exemplary illustration 500 of a graphical user interface displaying a dashboard. In an embodiment, the illustration 500 may include a downstream device 502. In an embodiment, the downstream device may display a graphical user interface 504. In an embodiment, the graphical user interface 504 may include a header 506. As used in this disclosure, a “header” is a GUI component that appears at the top of a display screen and provides contextual or navigational information. In an embodiment, the header 506 may display the current section title, such as “Executive Dashboard.” Without limitation, the header 506 may also include branding elements, user identifiers, quick-access controls such as notification icons or help menus, and the like. For example, without limitation, the header 506 may dynamically update to reflect the specific module or task currently being viewed by the user, such as “Performance Reviews” or “Quarterly Planning.”

With continued reference to FIG. 5, in an embodiment, the graphical user interface 504 may include a first window 508. As used in this disclosure, a “first window” is a section of the GUI that displays personalized content. In an embodiment, the first window 508 may greet the user by name such as, “Welcome back, Geoff” and provide a high-level description of the dashboard's purpose. Without limitation, the first window 508 may serve as a launch point for context-aware prompts, display recently viewed strategic materials, or surface system notifications that require executive attention. The graphical user interface 504 may include one or more windows.

With continued reference to FIG. 5, in an embodiment, the graphical user interface 504 may include a side panel 510. As used in this disclosure, a “side panel” is a vertically oriented menu bar that provides navigation across different dashboard categories or tools. In an embodiment, side panel 510 may include selectable categories such as “Strategy & Signals,” “Annual Plan,” “Culture,” “Team Alignment,” “Performance,” and the like. Without limitation, selecting any of these entries may load relevant content in the main display area. The side panel 510 may reflect access permissions or personalization based on the user's organizational role, such as CEO, department lead, or advisor. In an embodiment, the graphical user interface 504 may include one or more information panels 512. As used in this disclosure, an “information panel” is a discrete GUI element that presents a summary, metric, or prompt tied to a specific theme or strategic topic. In an embodiment, the information panels 512 may include labeled sections such as “Today's Focus,” “Strategic Pulse,” “Strategic Insights,” “Vision & Mission,” “Competitive Advantage,” “3-Year Strategic Goals,” and the like. Without limitation, each panel of the information panels 512 may be interactive, displaying underlying data or navigation links. For example, without limitation, the “Today's Focus” panel may link to a detailed schedule, while the “Strategic Insights” panel may link to metrics dashboards or natural language summaries of aggregated feedback.

With continued reference to FIG. 5, in an embodiment, the graphical user interface 504 may include a search bar 514. As used in this disclosure, a “search bar” is a GUI input element that allows users to submit search queries for locating relevant content across the interface. In an embodiment, search bar 514 may allow the user to search for strategy documents, team reflections, performance reviews, or definitions of company values. Without limitation, the search bar 514 may be augmented with natural language processing capabilities, allowing users to type queries such as “show insights from the marketing team” or “find goals related to Q3 product launch.”

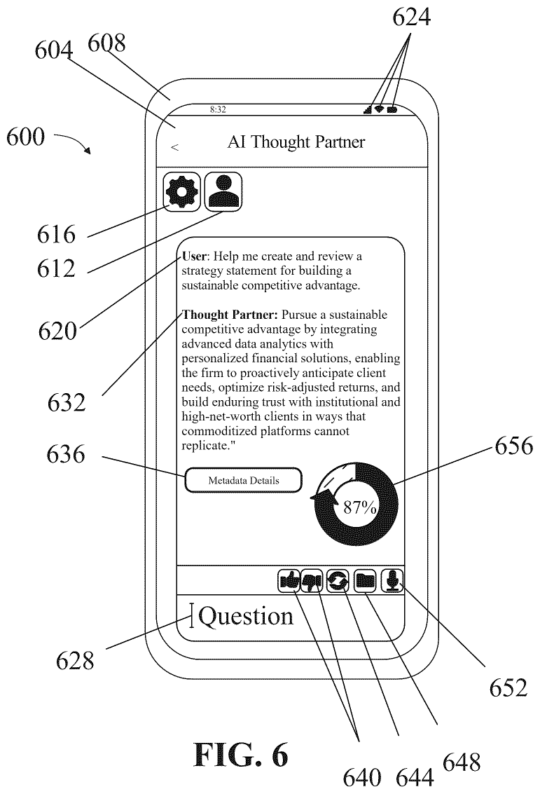

Referring now to FIG. 6, an exemplary illustration 600 of a graphical user interface displaying a dashboard. In an embodiment, the illustration 600 includes a downstream device 604. In an embodiment, the downstream device 604 displays a user interface 608. In an embodiment, the user interface 608 includes a graphical user interface.

In an embodiment, the user interface 608 displays a profile icon 612. A user may interact with profile icon 612 to view profile information, such as name, address, username, and the like.

In an embodiment, the user interface 608 displays a settings icon 616. A user may interact with settings icon 616 to change user settings. User settings may include, as non-limiting examples, preferred methods of communication (TEAMS, SLACK, ZOOM, SMS, email, WHATSAPP, and the like), preferred tones of communications, goals, strategies, and the like.

In an embodiment, the user interface 608 displays an inquiry 620. An inquiry 620 may include an inquiry datum 120 (discussed further with respect to FIG. 1). Inquiry 620 may include a question or request from a user. Inquiry 620 may be received from a user through textual input or audio input.

In an embodiment, the user interface 608 displays one or more status signals 624. Status symbols 624 may include information regarding the operation or capability of the downstream device. Status symbols 624 may include, as a non-limiting example, a cellular network meter. Cellular network meter display a relative strength of a cellular network or data network signal. Status symbols 624 may include, as a non-limiting example, a WiFi meter. WiFi meter may display a strength of a WiFi signal. Status symbols 624 may include, as a non-limiting example, a battery meter. In some embodiments, battery meter may display data regarding a capacity and/or charge level of an energy source, such as a rechargeable battery.

In an embodiment, the user interface 608 displays user input field 628. In some embodiments, user input field 628 may include a textual entry field. In some embodiments, user input field 628 may include a button with which user may trigger recording for audio input.

In an embodiment, the user interface 608 displays an output 632. In some embodiments, an output 632 may include textual data. In some embodiments, output 632 may include pictorial data. In some embodiments, output 632 may include audio data. In some embodiments, output 632 may include multimodal output, wherein output 632 comprises data of differing modalities. Differing modalities may include, as non-limiting examples.

In an embodiment, the user interface 608 displays metadata details 636. In some embodiments, metadata details 636 may include metadata regarding inquiry 620 or output 632. For example, it may include the time at which inquiry 620 was received or the time at which output 632 was generated. Metadata details 636 may include a source identifier, which may inform the user of the specific origin of a key data point used in the generation of the optimal output. For instance, the source identifier may appear as a label such as “Based on Q2 Supplier Report” or “Data pulled from Regulatory Update API,” enabling transparency and trust in the output of the apparatus 100. This display capability may assist users in validating results, exploring supporting information, and making informed decisions.

In an embodiment, the user interface 608 displays one or more feedback buttons 640. Feedback buttons may allow the user to input feedback on output 632 easily. Feedback buttons 640 may include, as a non-limiting example, a thumbs up button, which may allow a user to input positive feedback. Feedback buttons 640 may include, as a non-limiting example, a thumbs down button, which may allow a user to input negative feedback. In some embodiments, feedback buttons 640 may allow a user to rate output 632 on a scale (e.g., out of ten or a star rating). In some embodiments, feedback buttons 640 may allow a user to, when pressed, open a text box with which feedback can be submitted.

In some embodiments, the user interface 608 displays a refresh button 644. Refresh button, when pressed by a user, may cause statistics in user interface 608 to be recalculated. Refresh button, when pressed by a user, may cause output 632 to be regenerated—as a non-limiting example, output 632 may be regenerated using more up-to-date data.

In some embodiments, user interface 608 may include a local storage button 648. Local storage button 648 may allow users to access local storage on the device. For example, this may allow users to select local (or cloud-stored) filed to include in inquiry 620.

In some embodiments, user interface 608 may include a microphone button 652. Microphone button 652, when pressed, may allow a user to trigger audio recording or transcription of their speech. For example, microphone button 652 may be used by user to record audio for inquiry 620 or feedback.

In some embodiments, user interface 608 may include a score 656. Score 656 may include any score disclosed with reference to FIG. 1.

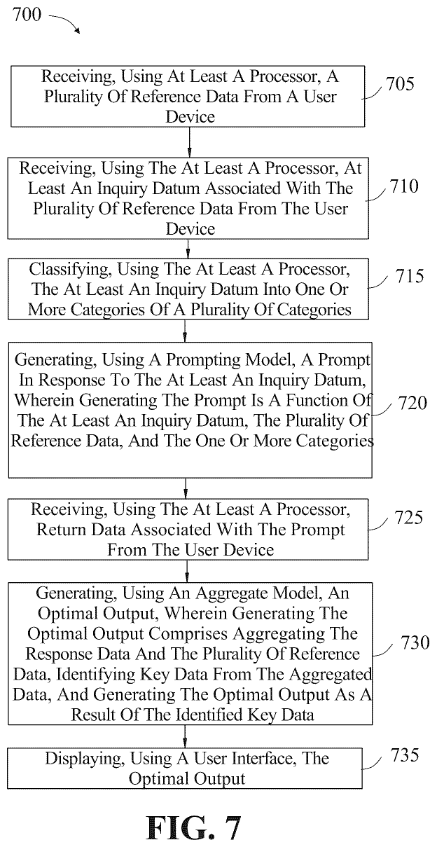

Referring now to FIG. 7, a flow diagram of an exemplary method 700 generating an optimal output is illustrated. At step 705, method 700 includes receiving, using at least a processor, a plurality of reference data from a user device. In an embodiment, the at least a processor may be further configured to normalize the plurality of reference data and generate a plurality of processed data using the plurality of reference data. This may be implemented as described and with reference to FIGS. 1-6.

Still referring to FIG. 7, at step 710, method 700 includes receiving, using the at least a processor, at least an inquiry datum associated with the plurality of reference data from the user device. This may be implemented as described and with reference to FIGS. 1-6.

Still referring to FIG. 7, at step 715, method 700 includes classifying, using the at least a processor, the at least an inquiry datum into one or more categories of a plurality of categories. This may be implemented as described and with reference to FIGS. 1-6.

Still referring to FIG. 7, at step 720, method 700 includes generating, using a prompting model, a prompt in response to the at least an inquiry datum, wherein generating the prompt is a function of the at least an inquiry datum, the plurality of reference data, and the one or more categories. In an embodiment, the prompt may include a gap inquiry configured to elicit additional data, wherein the gap inquiry is associated with an identified gap in the plurality of reference data. In an embodiment, the at least a processor may be further configured to train the prompting model with prompting training dataset, the prompting training dataset comprises historical prompts associated to historical inquiries. This may be implemented as described and with reference to FIGS. 1-6.

Still referring to FIG. 7, at step 725, method 700 includes receiving, using the at least a processor, return data associated with the prompt from the user device. This may be implemented as described and with reference to FIGS. 1-6.

Still referring to FIG. 7, at step 730, method 700 includes generating, using an aggregate model, an optimal output, wherein generating the optimal output comprises aggregating the return data and the plurality of reference data, identifying key data from the aggregated data, and generating the optimal output as a result of the identified key data. In an embodiment, the at least a processor may be further configured to aggregate, using the aggregate model, the return data and the plurality of reference data by converting the return data and the plurality of reference data into corresponding vector embeddings, and combining the vector embeddings into a unified semantic space. In an embodiment, the at least a processor may be further configured to identify, using the aggregate model, the key data from the aggregated data by performing dimensionality reduction on the unified semantic space, clustering reduced embeddings into a plurality of clusters, and selecting a representative data point from each cluster of the plurality of clusters based on a scoring function. This may be implemented as described and with reference to FIGS. 1-6.

Still referring to FIG. 7, at step 735, method 700 includes displaying, using a user interface, the optimal output. In an embodiment, the at least a processor may be further configured to refine the optimal output based on user feedback received after an initial optimal output, the user feedback comprising a correction datum. In an embodiment, the at least a processor may be further configured to refine, using a retrieval-augmented generation system, the optimal output by retrieving, using the at least a processor, supplemental data from at least one external source based on the inquiry datum and the plurality of reference data, and incorporating, using the at least a processor, the supplemental data into a contextual input received by the prompting model, and refining, using the at least a processor, the optimal output based on contextual input. In an embodiment, the at least a processor may be further configured to generate a score associated with the optimal output, wherein generating the score comprises ranking, using the at least a processor, a plurality of optimal outputs, assigning, using the at least a processor, scores to each of the plurality of optimal outputs based on a similarity metric, and displaying, using the user interface, the score. In an embodiment, the at least a processor may be further configured to display, using the user interface, at least a visual element associated with the optimal output and the score, wherein the at least a visual element comprises metadata, wherein the metadata comprising a source identifier. This may be implemented as described and with reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

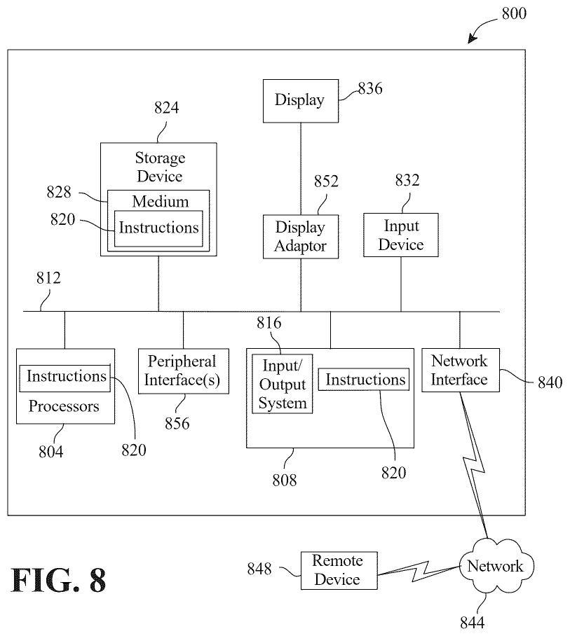

FIG. 8 shows a diagrammatic representation of one embodiment of computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display device 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for generating an optimal output, wherein the apparatus comprises:
at least a computing device, wherein the computing device comprises:
a memory; and
at least a processor communicatively connected to the memory, wherein the memory contains instructions configuring the at least a processor to:
receive a plurality of reference data from a user device;
receive at least an inquiry datum associated with the plurality of reference data from the user device;
classify, using the at least a processor, the at least an inquiry datum into one or more categories of a plurality of categories;
generate, using a prompting model, a prompt in response to the at least an inquiry datum, wherein generating the prompt is a function of the at least an inquiry datum, the plurality of reference data, and the one or more categories;
receive, using the at least a processor, return data associated with the prompt from the user device;
generate, using an aggregate model, an optimal output, wherein generating the optimal output comprises:
aggregating the return data and the plurality of reference data;
identifying key data from the aggregated data; and
generating the optimal output as a result of the identified key data; and
display, using a user interface, the optimal output.

2. The apparatus of claim 1, wherein the prompt comprises a gap inquiry configured to elicit additional data, wherein the gap inquiry is associated with an identified gap in the plurality of reference data.

3. The apparatus of claim 1, wherein the at least a processor is further configured to train the prompting model with prompting training dataset, the prompting training dataset comprises historical prompts associated to historical inquiries.

4. The apparatus of claim 1, wherein the at least a processor is further configured to aggregate, using the aggregate model, the return data and the plurality of reference data by:
converting the return data and the plurality of reference data into corresponding vector embeddings; and
combining the vector embeddings into a unified semantic space.

5. The apparatus of claim 4, wherein the at least a processor is further configured to identify, using the aggregate model, the key data from the aggregated data by:
performing dimensionality reduction on the unified semantic space;
clustering reduced embeddings into a plurality of clusters; and
selecting a representative data point from each cluster of the plurality of clusters based on a scoring function.

6. The apparatus of claim 1, wherein the at least a processor is further configured to refine the optimal output based on user feedback received after an initial optimal output, the user feedback comprising a correction datum.

7. The apparatus of claim 1, wherein the at least a processor is further configured to refine, using a retrieval-augmented generation system, the optimal output by:
retrieving, using the at least a processor, supplemental data from at least one external source based on the inquiry datum and the plurality of reference data;
incorporating, using the at least a processor, the supplemental data into a contextual input received by the prompting model; and
refining, using the at least a processor, the optimal output based on contextual input.

8. The apparatus of claim 1, wherein the at least a processor is further configured to generate a score associated with the optimal output, wherein generating the score comprises:
ranking, using the at least a processor, a plurality of optimal outputs;
assigning, using the at least a processor, scores to each of the plurality of optimal outputs based on a similarity metric; and
displaying, using the user interface, the score.

9. The apparatus of claim 8, wherein the at least a processor is further configured to display, using the user interface, at least a visual element associated with the optimal output and the score, wherein the at least a visual element comprises metadata, wherein the metadata comprising a source identifier.

10. The apparatus of claim 1, wherein the at least a processor is further configured to:
normalize the plurality of reference data; and
generate a plurality of processed data using the plurality of reference data.

11. A method for generating an optimal output, wherein the method comprises:
receiving, using at least a processor, a plurality of reference data from a user device;
receiving, using the at least a processor, at least an inquiry datum associated with the plurality of reference data from the user device;
classifying, using the at least a processor, the at least an inquiry datum into one or more categories of a plurality of categories;
generating, using a prompting model, a prompt in response to the at least an inquiry datum, wherein generating the prompt is a function of the at least an inquiry datum, the plurality of reference data, and the one or more categories;
receiving, using the at least a processor, return data associated with the prompt from the user device;
generating, using an aggregate model, an optimal output, wherein generating the optimal output comprises:
aggregating the return data and the plurality of reference data;
identifying key data from the aggregated data; and
generating the optimal output as a result of the identified key data; and
displaying, using a user interface, the optimal output.

12. The method of claim 11, further comprising generating the prompt with a gap inquiry, wherein the gap inquiry is associated with an identified gap in the plurality of reference data and elicits additional data.

13. The method of claim 11, further comprising training, using the at least a processor, the prompting model with prompting training dataset, the prompting training dataset comprises historical prompts associated to historical inquiries.

14. The method of claim 11, further comprising aggregating, using the aggregate model, the return data and the plurality of reference data by:
converting the return data and the plurality of reference data into corresponding vector embeddings; and
combining the vector embeddings into a unified semantic space.

15. The method of claim 14, further comprising identifying, using the aggregate model, the key data from the aggregated data by:
performing dimensionality reduction on the unified semantic space;
clustering reduced embeddings into a plurality of clusters; and
selecting a representative data point from each cluster of the plurality of clusters based on a scoring function.

16. The method of claim 11, further comprising refining, using the at least a processor, the optimal output based on user feedback received after an initial optimal output, the user feedback comprising a correction datum.

17. The method of claim 11, further comprising refining, using a retrieval-augmented generation system, the optimal output by:
retrieving, using the at least a processor, supplemental data from at least one external source based on the inquiry datum and the plurality of reference data;
incorporating, using the at least a processor, the supplemental data into a contextual input received by the prompting model; and
refining, using the at least a processor, the optimal output based on contextual input.

18. The method of claim 11, further comprising generating, using the at least a processor, a score associated with the optimal output, wherein generating the score comprises:
ranking, using the at least a processor, a plurality of optimal outputs;
assigning, using the at least a processor, scores to each of the plurality of optimal outputs based on a similarity metric; and
displaying, using the user interface, the score.

19. The method of claim 18, further comprising displaying, using the user interface, at least a visual element associated with the optimal output and the score, wherein the at least a visual element comprises metadata, wherein the metadata comprising a source identifier.

20. The method of claim 11, further comprising:
normalizing, using the at least a processor, the plurality of reference data; and
generating, using the at least a processor, a plurality of processed data using the plurality of reference data.
